(19) United States
(12) Patent Application Publication
(10) Pub. No.: US 2016/0085782 A1
(43) Pub. Date: Mar. 24, 2016

(54) UPDATE METHOD AND UPDATING DEVICE

(71) Applicant: FUJITSU LIMITED, Kawasaki-shi, Kanagawa (JP)

(72) Inventors: Yoshihiro TSUJIKAWA, Kobe (JP); Masaki Nishigaki, Kobe (JP); Naoki Nakatogawa, Kawasaki (JP)

(73) Assignee: FUJITSU LIMITED, Kawasaki-shi, Kanagawa (JP)

(21) Appl. No.: 14/831,133

(22) Filed: Aug. 20, 2015

(30) Foreign Application Priority Data
Sep. 24, 2014 (JP) 2014-194380

(51) Int. Cl. G06F 17/30

(52) U.S. Cl. CPC G06F 17/30321; G06F 17/30345

(57) ABSTRACT

An update method executed by a computer includes: recording a history of processes executed on records in a database in accordance with a request; generating a second index, respectively, for a plurality of new records added to the database in accordance with another request, by applying a storage position to a first index of the plurality of records respectively; and reflecting, to the second index, at least one process from among the processes, the at least one process being executed after a start of the generating of the second index.

### CROSS-REFERENCE TO RELATED APPLICATION

This application is based upon and claims the benefit of priority of the prior Japanese Patent Application No. 2014-194380, filed on Sep. 24, 2014, the entire contents of which are incorporated herein by reference.

### FIELD

The embodiment discussed herein is related to a technique for updating a database.

### BACKGROUND

There is a method for executing collective update so as to add data including a large number of records to a database, as well as a method for individually updating each record in accordance with an access request such as an SQL (that is not an abbreviated word as a standard, but indicates Structured Query Language in some cases) statement.

When the database is to be collectively updated, other update of the database is excluded in order to ensure the matching of an index with data after the update in many cases. For example, the access request such as the SQL statement is limited.

For example, it is desirable that, for a user who uses a database by online transaction processing (OLTP), the processing be continuously executed. A related technique is disclosed in Japanese Laid-open Patent Publication No. 2006-251990, for example.

### SUMMARY

According to an aspect of the invention, an update method executed by a computer includes: recording a history of processes executed on records in a database in accordance with a request; generating a second index, respectively, for a plurality of new records added to the database in accordance with another request, by applying a storage position to a first index of the plurality of records respectively; and reflecting, to the second index, at least one process from among the processes, the at least one process being executed after a start of the generating of the second index.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network configuration;

FIG. 2 is a diagram illustrating an example of a main module configuration;

FIG. 3 is a diagram illustrating an example of the configuration of data of a table;

FIG. 4 is a diagram illustrating an example of a configuration of a leaf node region;

FIG. 5 is a diagram illustrating an example of the configuration of data of a new table;

FIG. 6 is a diagram illustrating an example of a sequence;

FIG. 7 is a diagram illustrating an example of the flow of data in an addition mode;

FIG. 8 is a diagram illustrating a state in which an existing leaf node region is updated;

FIG. 9 is a diagram illustrating an example in which an archive log is applied to a new leaf node region;

FIG. 10 is a diagram describing patterns;

FIG. 11 is a diagram illustrating the outline of data access in a first pattern;

FIG. 12 is a diagram illustrating the outline of data access in a second pattern;

FIG. 13 is a diagram illustrating the outline of data access in a third pattern;

FIG. 14 is a diagram illustrating an example of duplication of nodes in a generation process;

FIG. 15 is a diagram illustrating an example of duplication of nodes in a reflection process;

FIG. 16 is a diagram illustrating an example of the configuration of a data storage unit;

FIG. 17 is a diagram illustrating an example of the configuration of a transaction table;

FIG. 18 is a diagram illustrating an example of the configuration of control data;

FIG. 19 is a diagram illustrating an example of the configuration of an executing unit;

FIG. 20 is a flowchart of a main process to be executed by the executing unit;

FIG. 21 is a flowchart of a process of starting a transaction;

FIG. 22 is a flowchart of a control process for the transaction;

FIG. 23 is a flowchart of a pattern determination process;

FIG. 24 is a flowchart of a record extraction process;

FIG. 25A is a flowchart of a record insertion process;

FIG. 25B is a flowchart of the record insertion process;

FIG. 26A is a flowchart of a record deletion process;

FIG. 26B is a flowchart of the record deletion process;

FIG. 27A is a flowchart of a record update process;

FIG. 27B is a flowchart of the record update process;

FIG. 27C is a flowchart of the record update process;

FIG. 27D is a flowchart of the record update process;

FIG. 28 is a flowchart of a process of completing the transaction;

FIG. 29 is a flowchart of a process of cancelling the transaction;

FIG. 30 is a diagram illustrating an example of the configuration of a collectively adding unit;

FIG. 31 is a flowchart of a collective addition process;

FIG. 32 is a flowchart of the collective addition process;

FIG. 33 is a flowchart of the generation process;

FIG. 34 is a flowchart of the generation process;

FIG. 35 is a flowchart of the generation process;

FIG. 36 is a flowchart of the reflection process;

FIG. 37 is a flowchart of a first subroutine process;

FIG. 38 is a flowchart of a second subroutine process;

FIG. 39 is a diagram illustrating a state in which a cancellation log is applied;

FIG. 40 is a flowchart of a cancellation verification process;

FIG. 41 is a flowchart of a standby process; and

FIG. 42 is a hardware configuration of a computer.

### DESCRIPTION OF EMBODIMENT

According to an aspect, a technique disclosed in an embodiment enables individual update to be executed during collective update of a database.

### Embodiment

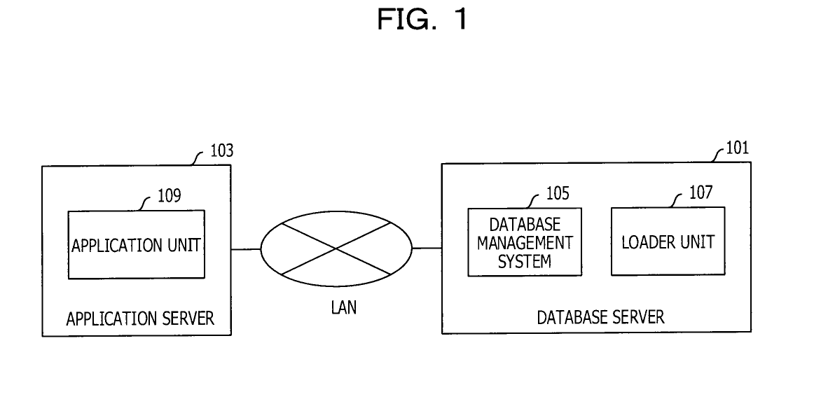

FIG. 1 illustrates an example of a network configuration. In this example, a database server 101 and an application server 103 are connected to each other through a local area network (LAN). The database server 101 includes a database management system 105 and a loader unit 107. The application server 103 includes an application unit 109.

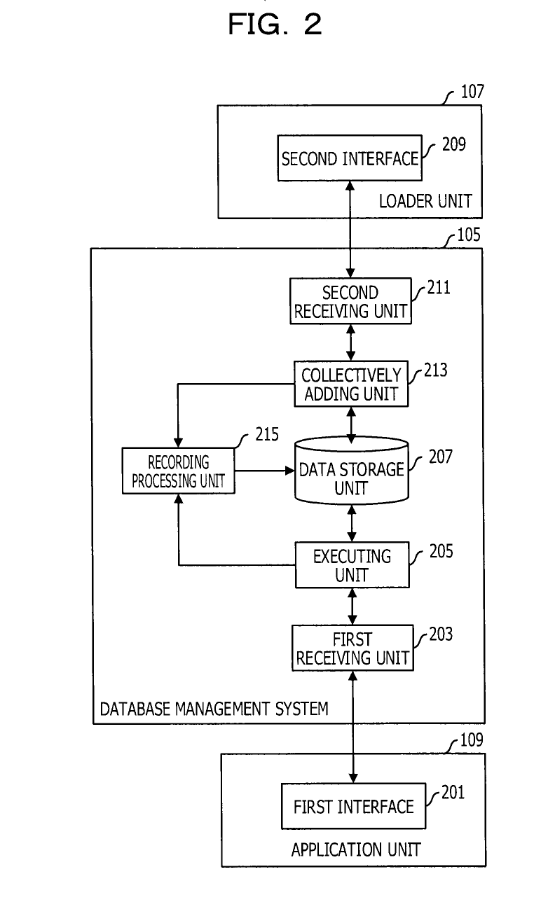

FIG. 2 illustrates an example of a main module configuration. The application unit 109 uses data of the database management system 105 by online transaction processing. The application unit 109 includes a first interface 201. The first interface 201 issues an SQL statement to the database management system 105 and receives the results of the SQL statement.

The database management system 105 includes a first receiving unit 203 and an executing unit 205 in order to execute the online transaction processing. The first receiving unit 203 receives the SQL statement through the LAN. The executing unit 205 executes a process based on the received SQL statement.

The database management system 105 also includes a data storage unit 207. The data storage unit 207 stores data included in a database, control data, and the like.

The loader unit 107 executes a process of collectively loading data acquired from another database or another system, for example. The loader unit 107 includes a second interface 209. The second interface 209 is used in order to use direct path loading. In the direct path loading, data is updated at a high speed. For the direct path loading, there is no concept of transactions.

The database management system 105 includes a second receiving unit 211 and a collectively adding unit 213 in order to collectively add data by the direct path loading. The second receiving unit 211 receives a request (hereinafter referred to as add request) to collectively add data, for example. The collectively adding unit 213 collectively adds the data in accordance with the received add request. An example in which multiple records are added to a table of the database managed by the database management system 105 at one time is described below. The database management system 105 also includes a recording processing unit 215. The recording processing unit 215 executes a process of recording an archive and a process of recording a cancellation log.

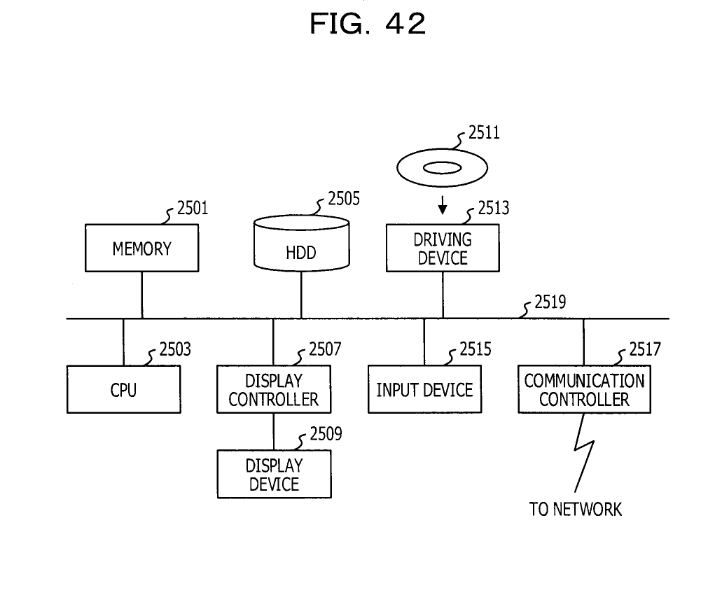

The database management system 105, the first receiving unit 203, the executing unit 205, the second receiving unit 211, the collectively adding unit 213, and the recording processing unit 215 that are described above are achieved using hardware resources (for example, hardware resources illustrated in FIG. 42) and a program that causes a processor to execute processes described later.

The data storage unit 207 is achieved using a hardware resource (for example, a hardware resource illustrated in FIG. 42).

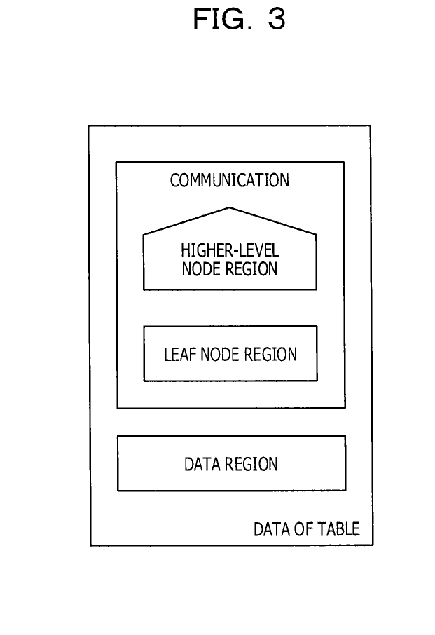

Next, data of the table of the database is described. FIG. 3 illustrates an example of the configuration of the data of the table. The data of the table of the database includes an index region and a data region. For the index region, the configuration of a B-tree is used, for example. The B-tree is a balanced tree. The configuration of the B-tree is widely used in relational databases (RDBs). In addition, an index of the B-tree includes a leaf node and a higher-level node (hereinafter merely referred to as higher-level node) for the leaf node. In the data region, data of records is stored. FIG. 3 illustrates a configuration in a normal mode.

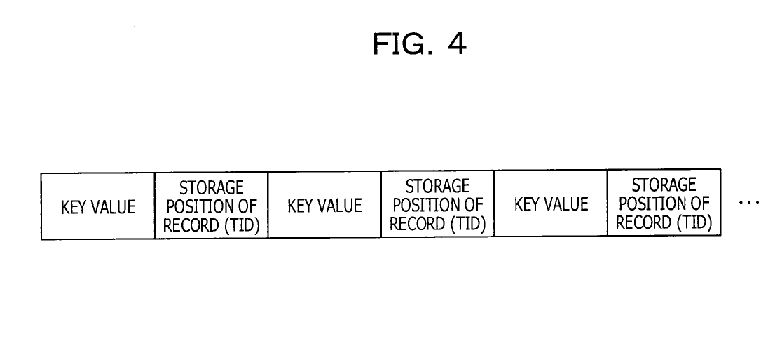

FIG. 4 illustrates an example of the configuration of the leaf node region. As illustrated in FIG. 4, in the leaf node region, pairs of key values and storage positions (hereinafter referred to as TIDs in some cases) of records are stored in order of ascending key value. The pairs of key values and TIDs correspond to leaf nodes. Specifically, a key value and a TID are associated with each other in each leaf node. The pairs of key values and record storage positions are assigned to the leaf nodes in order of ascending key value. The key values are used to identify the records included in the table. The storage positions of the records are positions at which the records identified by the key values are stored in the data region. Hereinafter, the leaf nodes are referred to as nodes.

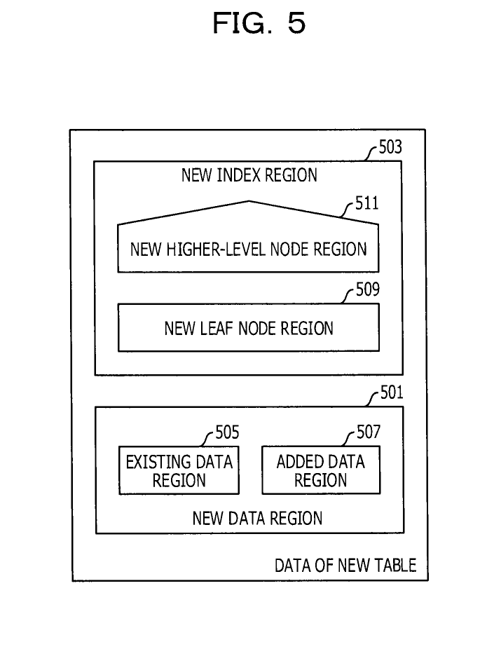

Next, the configuration of data of a new table after data is collectively added is described. FIG. 5 illustrates an example of the configuration of the data of the new table. The data of the new table includes a new data region 501 and a new index region 503. The new data region 501 includes an existing data region 505 and an added data region 507. The existing data region 505 corresponds to a data region before the execution of the collective addition of data. The added data region 507 is a data region added by the collective addition of the data. In the new index region 503, an index to be used to access the existing data region 505 and added data region 507 included in the new data region 501 is stored. The new index region 503 includes a new leaf node region 509 and a new higher-level node region 511.

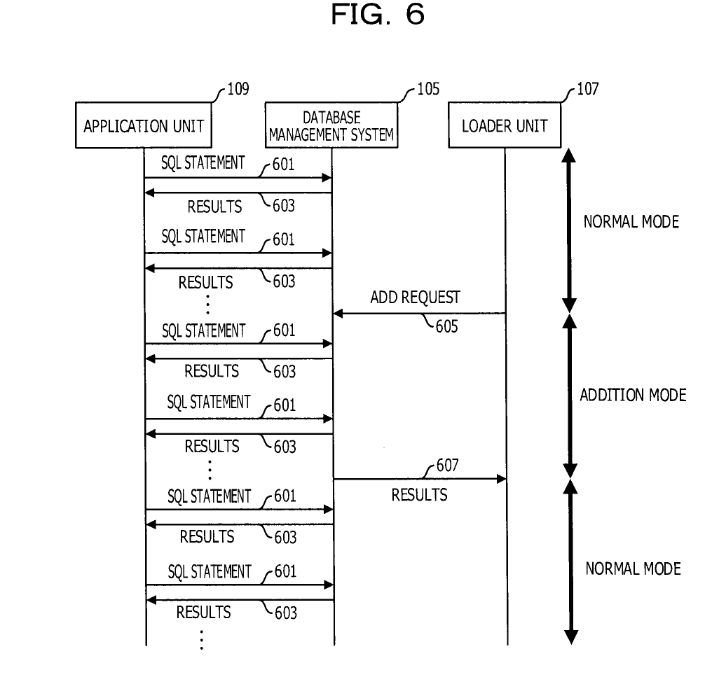

Next, a sequence according to the embodiment is described. FIG. 6 illustrates an example of the sequence. The application unit 109 transmits an SQL statement 601 to the database management system 105 by the online transaction processing. The database management system 105 executes a process based on the received SQL statement 601. The database management system 105 returns results 603 of the process to the application unit 109.

During the time when the application unit 109 and the database management system 105 execute the aforementioned online transaction processing, the loader unit 107 transmits an add request 605 to the database management system 105. The database management system 105 collectively adds data in accordance with the received add request 605 and returns results 607 of the collective addition to the loader unit 107.

In the embodiment, data is collectively added without the interruption of the online transaction processing. In the example, a mode of the database management system 105 during the time when a process of collectively adding data is executed is referred to as an addition mode. A mode of the database management system 105 that is not in the addition mode is referred to as a normal mode.

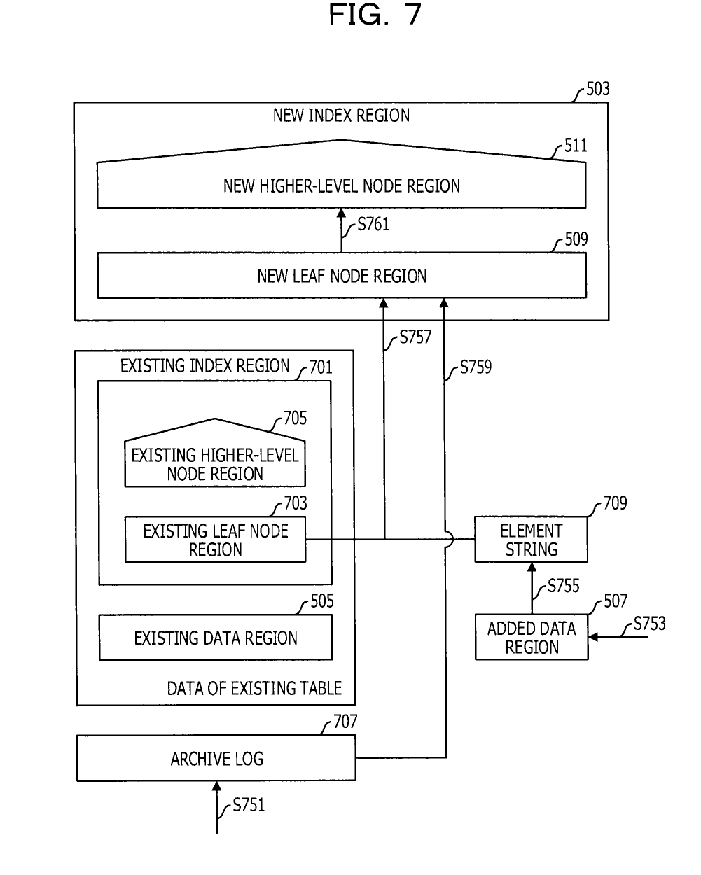

Next, the flow of data in the addition mode is described. FIG. 7 illustrates an example of the flow of the data in the addition mode. Data of an existing table includes the aforementioned existing data region 505 and an existing index region 701. The existing index region 701 includes an existing leaf node region 703 and an existing higher-level node region 705. In the normal mode and the addition mode, when the database management system 105 executes the process based on the SQL statement 601, details of the process are recorded in an archive log 707 (in S751).

Added data is stored in the added data region 507 (S753). Then, an element string 709 is extracted from the added data (S755). Elements of the element string 709 are pairs of key values and TIDs. The pairs of key values and TIDs are held by nodes of the new leaf node region 509. The key values and the TIDs are associated with each other in the elements in the same manner as the nodes. A procedure for extracting the element string 709 from the added data is the same as or similar to a conventional procedure for generating leaf nodes.

Then, the database management system 105 merges nodes of the existing leaf node region 703 with the elements of the element string 709 and causes the nodes and the elements to be stored in the new leaf node region 509 (in S757). The process of S757 is referred to as a generation process.

In the embodiment, however, the process based on the SQL statement 601 is executed during the merger process. The process that is based on the SQL statement 601 and executed during the merger process is read from the archive log 707 and the new leaf node region 509 is additionally updated together with the processes (S759). The process of S759 is referred to as a reflection process.

Then, the new higher-level node region 511 is generated based on the new leaf node region 509 generated by the generation process and the reflection process (S761). At the stage at which the new higher-level node region 511 is generated, a new index is completed.

The update of at least one of the nodes of the existing leaf node region 703 that is caused by the process that is based on the SQL statement 601 and executed during the generation process is reflected in the new leaf node region 509 in the generation process, while the update of the other nodes of the existing leaf node region 703 that is caused by the process that is based on the SQL statement 601 and executed during the generation process is not reflected in the new leaf node region 509 in the generation process.

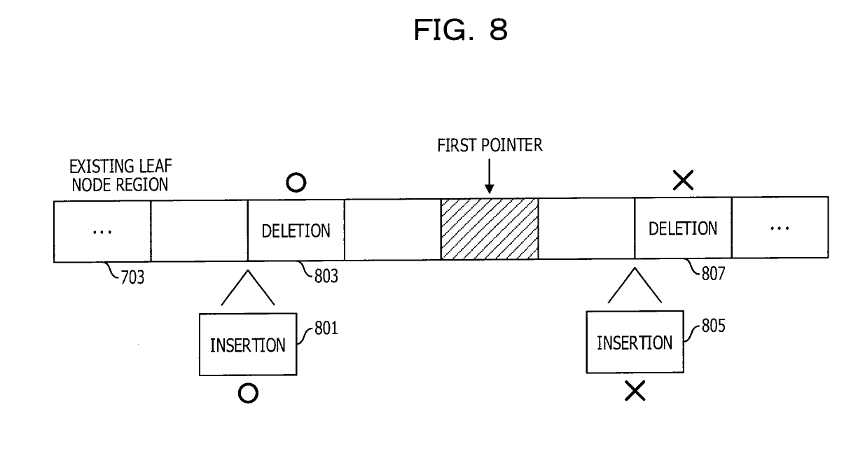

The update of the nodes of the existing leaf node region 703 that is caused by the process that is based on the SQL statement 601 and executed during the generation process is described below. FIG. 8 illustrates a state in which the existing leaf node region 703 is updated. The nodes of the existing leaf node region 703 are held in order of ascending key value. In an example illustrated in FIG. 8, a key value held by a node on the left side is small and a key value held by a node on the right side is large. A first pointer that indicates a node in the merger process is moved in a direction in which a key value increases. In the example illustrated in FIG. 8, the first pointer is moved from the left side to the right side.

As illustrated in FIG. 8, in a state in which the first pointer indicates a certain node, the insertion of a node 801 into a position through which the first pointer already passes is not reflected in the new leaf node region 509 in the generation process. In the same state, the deletion of a node 803 located at a position through which the first pointer already passes is not reflected in the new leaf node region 509 in the generation process. Thus, the insertion of the node 801 and the deletion of the node 803 are reflected in the new leaf node region 509 by the reflection process. In FIG. 8, circles indicate the update of the nodes that are reflected in the new leaf node region 509 by the reflection process.

As illustrated in FIG. 8, in the state in which the first pointer indicates the certain node, the insertion of a node 805 into a position through which the first pointer has yet to pass is reflected in the new leaf node region 509 in the generation process. In the same state, the deletion of a node 807 located at a position through which the first pointer has yet to pass is reflected in the new leaf node region 509 in the generation process. Thus, the insertion of the node 805 and the deletion of the node 807 are not reflected in the new leaf node region 509 by the reflection process. In FIG. 8, cross marks indicate the update of the nodes that are not reflected in the new leaf node region 509 by the reflection process.

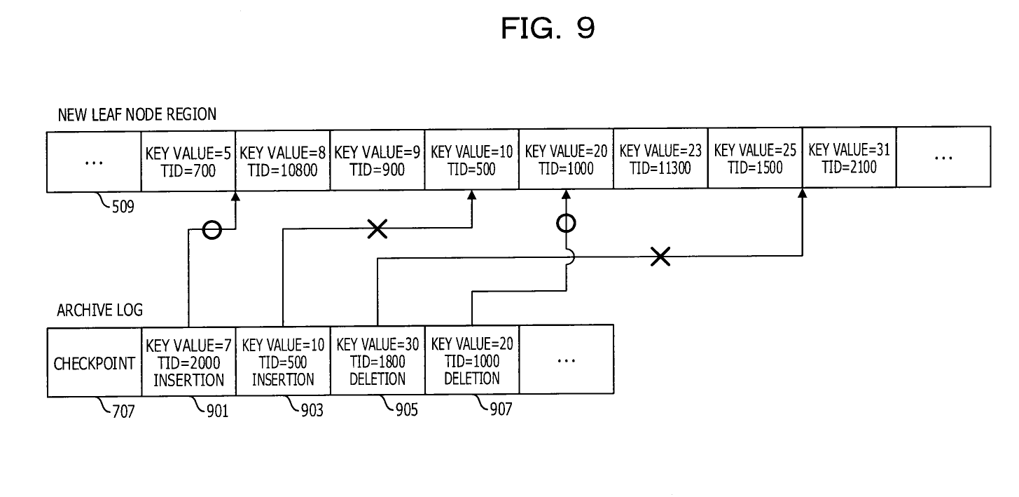

Next, an example in which the archive log 707 is applied to the new leaf node region 509 in the reflection process is described with reference to FIG. 9. A record 901 of the archive log 707 is added in a process corresponding to the insertion of the node 801 illustrated in FIG. 8. A node that holds a pair of a key value “7” and a TID “2000” is yet to be inserted in the new leaf node region 509. Thus, a process indicated by the record 901 is applied and the node that holds the pair of the key value “7” and the TID “2000” is inserted in the new leaf node region 509. In FIG. 9, circles indicate cases where processes indicated by records are applied.

A record 903 of the archive log 707 is added in a process corresponding to the insertion of the node 805 illustrated in FIG. 8. A node that holds a pair of a key value “10” and a TID “500” is already inserted in the new leaf node region 509, and thus a process indicated by the record 903 is not applied. In FIG. 9, cross marks indicate cases where processes indicated by records are not applied.

A record 905 of the archive log 707 is added in a process corresponding to the deletion of the node 807 illustrated in FIG. 8. A node that holds a pair of a key value “30” and a TID “1800” is already deleted from the new leaf node region 509, and thus a process indicated by the record 905 is not applied.

A record 907 of the archive log 707 is added in a process corresponding to the deletion of the node 803 illustrated in FIG. 8. A node that holds a pair of a key value “20” and a TID “1000” is yet to be deleted from the new leaf node region 509 and thus a process indicated by the record 907 is applied.

Even after the new index is completed by the reflection process, the existing index region 701 is used for processes based on SQL statements 601 issued in transactions started before the completion of the new index. Specifically, until all the transactions started before the completion of the new index are completely terminated, the existing index region 701 is set to be valid. By setting the existing index region 701 to be valid, the atomicity of a series of the processes by the transactions started before the completion of the new index is ensured. If the new index is used immediately after the completion of the new index in the transactions started before the completion of the new index, the number of records referenced by the application unit 109 abruptly increases upon the completion of the new index. As a result, preconditions of a process by the application unit 109 are not satisfied and discrepancy occurs. The atomicity indicates that either a state in which the series of processes by the transactions are completely executed or a state in which all the processes by the transactions are not executed is guaranteed.

In the embodiment, processes of handling records of the table, such as a record extraction process and a record insertion process, each have three patterns, and data access is executed in each of the patterns.

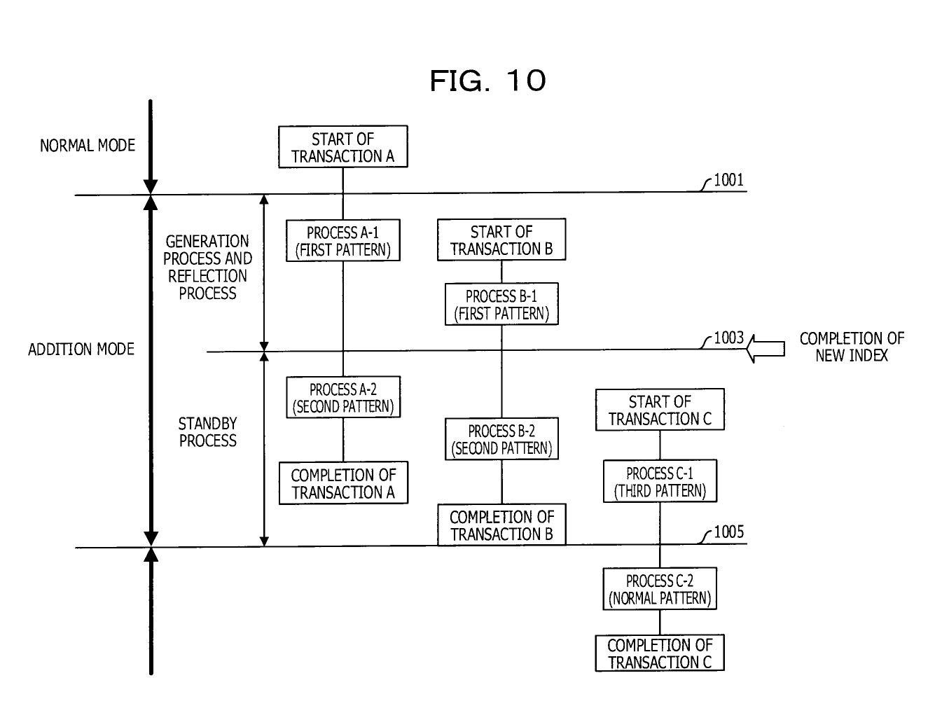

Three patterns are described with reference to FIG. 10. In FIG. 10, a downward direction represents the passage of time. At a time represented by 1001, the normal mode is switched to the addition mode. At a time represented by 1003, the new index is completed. At a time represented by 1005, all transactions started before the completion of the new index are completely terminated and the addition mode is switched to the normal mode.

As illustrated in FIG. 10, a time period of the addition mode is divided into a time period in which the new index region 503 is generated by the generation process and the reflection process and a time period of a standby process to the time when all the transactions started before the completion of the new index are completely terminated.

As illustrated in FIG. 10, a transaction A is started before the switching to the addition mode. A transaction B is started before the completion of the new index. A transaction C is started after the completion of the new index.

A process A-1 of the transaction A and a process B-1 of the transaction B are executed using the existing index region 701 since the new index is yet to be completed. In this example, this pattern is referred to as a first pattern.

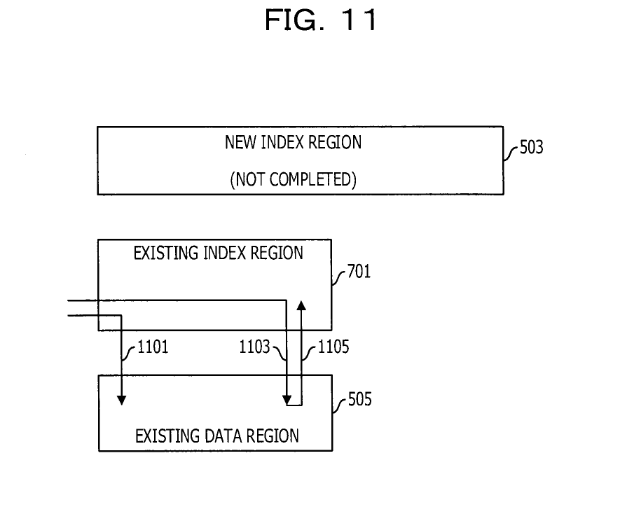

FIG. 11 illustrates the outline of data access in the first pattern. In the first pattern, in the record extraction process, an extractor references the existing index region 701 and accesses the existing data region 505, as represented by an arrow 1101, for example. In the first pattern, in the record insertion process, an inserting unit references the existing index region 701 and accesses the existing data region 505, as represented by an arrow 1103, and updates the existing index region 701, as represented by an arrow 1105, for example.

Return to the description of FIG. 10. A process A-2 of the transaction A and a process B-2 of the transaction B are executed using the existing index region 701 even after the new index is completed at the time represented by 1003. However, the matching of the existing index region 701 with the new index region 503 is executed. In this example, this pattern is referred to as a second pattern.

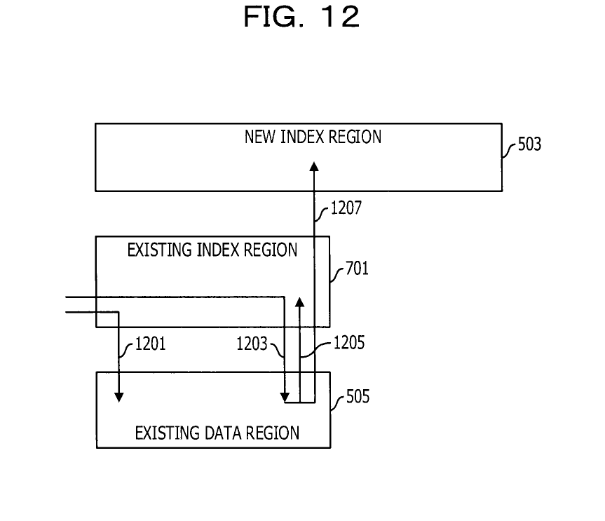

FIG. 12 illustrates the outline of data access in the second pattern. In the second pattern, in the record extraction process, the extractor references the existing index region 701 and accesses the existing data region 505, as represented by an arrow 1201, for example. In the second pattern, in the record insertion process, the inserting unit references the existing index region 701 and accesses the existing data region 505, as represented by an arrow 1203, and updates the existing index region 701, as represented by an arrow 1205, for example. In addition, the inserting unit also updates the new index region 503, as represented by an arrow 1207.

Return to FIG. 10. A process C-1 of the transaction C started after the new index is completed at the time represented by 1003 is executed using the new index region 503. However, the matching of the new index region 503 with the existing index region 701 is executed. In this example, this pattern is referred to as a third pattern.

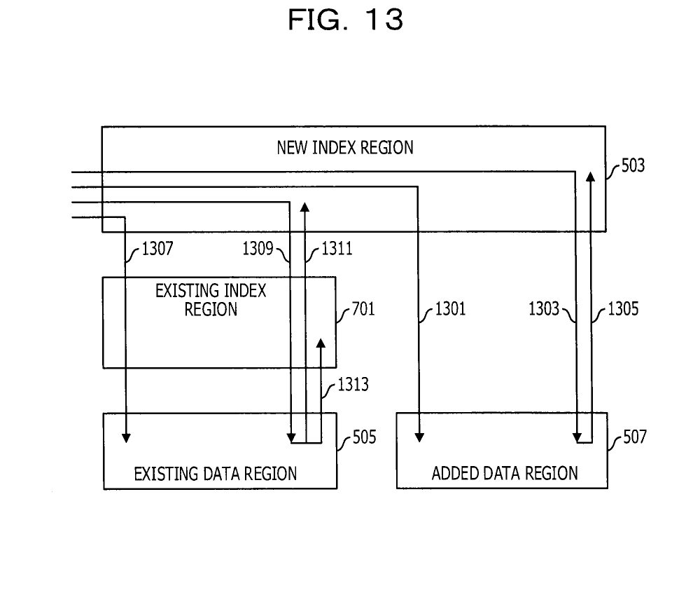

FIG. 13 illustrates the outline of data access in the third pattern. In the third pattern, there are a case where the added data region 507 is accessed and a case where the existing data region 505 is accessed.

For example, when the added data region 507 is to be accessed in the record extraction process, the extractor references the new index region 503 and accesses the added data region 507, as represented by an arrow 1301. For example, when the added data region 507 is to be accessed in the record insertion process, the inserting unit references the new index region 503 and accesses the added data region 507, as represented by an arrow 1303, and updates the new index region 503, as represented by an arrow 1305.

For example, when the existing data region 505 is to be accessed in the record extraction process, the extractor references the new index region 503 and accesses the existing data region 505, as represented by an arrow 1307. For example, when the existing data region 505 is to be accessed in the record insertion process, the inserting unit references the new index region 503 and accesses the existing data region 505, as represented by an arrow 1309, and updates the new index region 503, as represented by an arrow 1311. In addition, the inserting unit updates the existing index region 701, as represented by an arrow 1313.

Return to the description of FIG. 10. After the time represented by 1005, only the new index region 503 remains, and data access is executed using the new index region 503 in the record insertion process and a record update process. Specifically, the process C-2 of the transaction C is executed in a normal pattern of the normal mode.

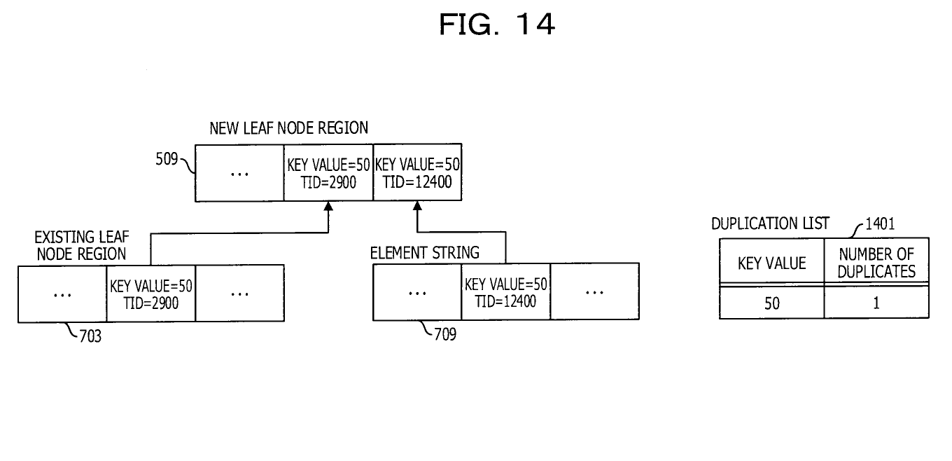

In the embodiment, whether or not duplication of nodes occurs due to the generation process is verified. FIG. 14 illustrates an example of duplication of nodes in the generation process. When a node that holds a pair of the key value “50” and a TID “2900” and is included in the existing leaf node region 703, and an element that holds a pair of the key value “50” and a TID “12400” and is included in the element string 709, are reflected in the new leaf node region 509, duplicate nodes that hold the same key value “50” exist.

If the duplicate nodes exist in the aforementioned manner, the key value “50”, and the number of duplicates that represents “1”, are associated with each other and stored in a duplication list 1401. The key value in the duplication list 1401 represents the duplicate key value.

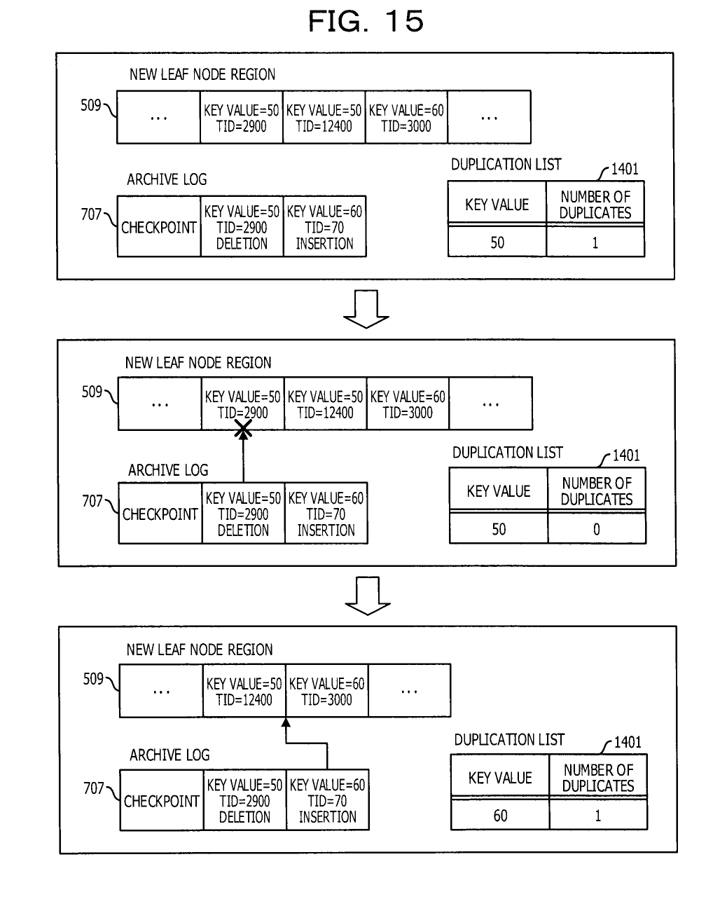

In the embodiment, whether or not duplication of nodes occurs is verified by the reflection process. FIG. 15 illustrates an example of duplication of nodes in the reflection process. An upper part of FIG. 15 represents a state in which duplication of nodes already occurs due to the generation process.

A middle part of FIG. 15 represents a state in which a process of applying a first record of the archive log 707 and deleting a node holding the pair of the key value “50” and the TID “2900” is executed in the reflection process. As a result, a single node holds the key value “50”. Thus, the duplication is removed. Then, the number of duplicates that is associated with the key value “50” becomes “0”. In this case, a record of the key value “50” is deleted from the duplication list 1401.

A lower part of FIG. 15 represents a state in which a process of applying a second record of the archive log 707 and inserting a node holding a pair of a key value “60” and a TID “70” is executed in the reflection process. As a result, duplicate nodes that hold the same key value “60” exist. If the duplication of the nodes occurs, information of the duplicate nodes is registered in the duplication list 1401. In this example, the key value “60”, and the number of duplicates that represents “1”, are associated with each other and stored in the duplication list 1401. If duplicate nodes that hold the same key value already exist, 1 is added to the number of duplicates.

Thus, there are a case where duplication of nodes is removed in the reflection process and a case where duplication of nodes occurs in the reflection process.

As described above, whether or not duplication of nodes occurs is verified through the generation process and the reflection process. If duplication of nodes occurs, the collective addition of data is cancelled. Thus, if the collective addition of data is successful, the uniqueness of the new leaf node region 509 is ensured.

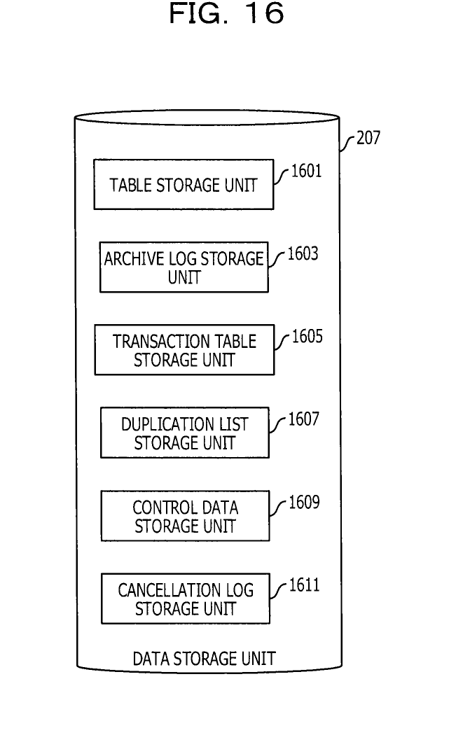

Next, the configuration of the data storage unit 207 is described. FIG. 16 illustrates an example of the configuration of the data storage unit 207. The data storage unit 207 includes a table storage unit 1601, an archive log storage unit 1603, a transaction table storage unit 1605, a duplication list storage unit 1607, a control data storage unit 1609, and a cancellation log storage unit 1611. The table storage unit 1601 stores the data (refer to FIG. 3) of the table managed by the database in the normal mode. In addition, the data storage unit 1601 stores data corresponding to the new index region 503 (illustrated in FIG. 7), the data (illustrated in FIG. 7) of the existing table, the added data region 507 (illustrated in FIG. 7), the element string 709 (illustrated in FIG. 7), and the like in the addition mode. The archive log storage unit 1603 stores the archive log 707. The transaction table storage unit 1605 stores a transaction table. The duplication list storage unit 1607 stores the duplication list 1401. The control data storage unit 1609 stores the control data. The cancellation log storage unit 1611 stores the cancellation log.

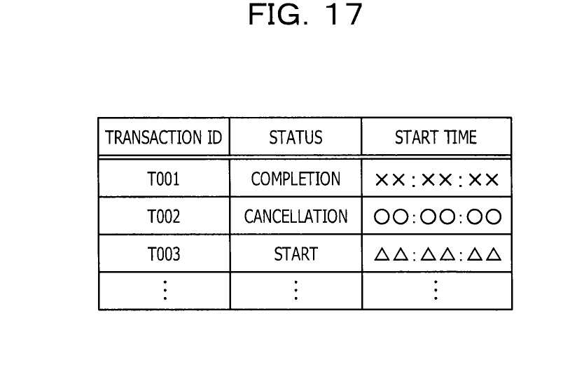

The transaction table is described below. FIG. 17 illustrates an example of the configuration of the transaction table. The transaction table described in the example includes records for transactions. The records each have a field for setting a transaction ID of a transaction, a field for setting a status of the transaction, and a field for setting a start time of the transaction. When the transaction is started, “start” is set in the status field. When the transaction is completed, “completion” is set in the status field. If the transaction is cancelled, “cancellation” is set in the status field at the time of the cancellation of the transaction. Specifically, if “start” is set in the status field, the status field indicates that the transaction continues.

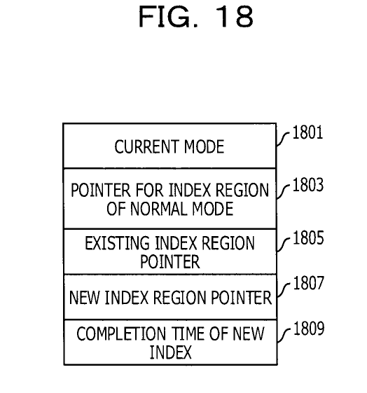

Next, the control data is described below. FIG. 18 illustrates an example of the configuration of the control data. The control data storage unit 1609 has a field for setting a current mode 1801. The current mode 1801 is either the “normal mode” or the “addition mode”. If the current mode 1801 is the “normal mode”, a pointer 1803 provided for the index region of the normal mode and included in the control data storage unit 1609 is used. The pointer 1803 for the index region of the normal mode is used when the index region is accessed in the normal mode.

If the current mode 1801 is the “addition mode”, an existing index region pointer 1805, a new index region pointer 1807, and a completion time 1809 of the new index that are included in the control data storage unit 1609 are used. The existing index region pointer 1805 is used when the existing index region 701 is accessed in the addition mode. The new index region pointer 1807 is used when the new index region 503 is accessed in the addition mode. The completion time 1809 of the new index represents the time when the new index region 503 becomes valid.

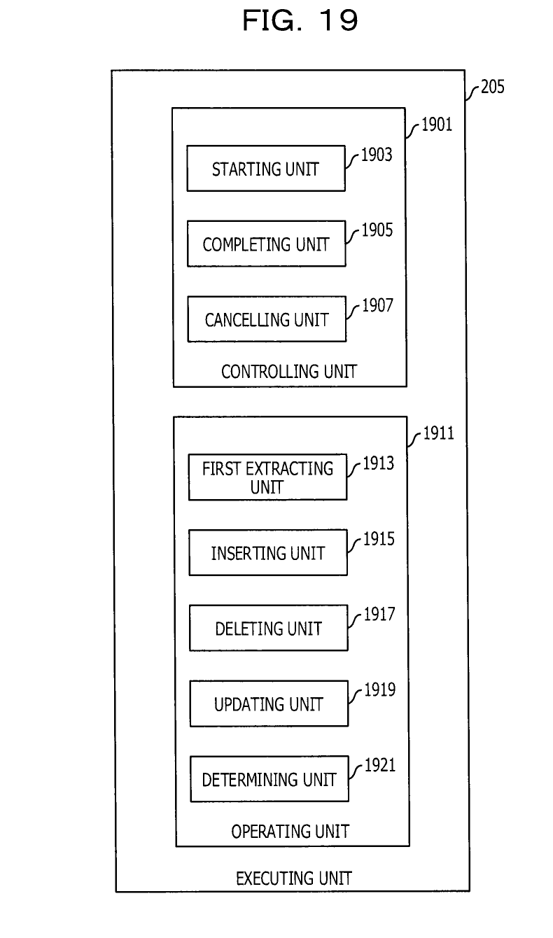

FIG. 19 illustrates an example of the configuration of the executing unit 205. The executing unit 205 includes a controlling unit 1901 and an operating unit 1911. The controlling unit 1901 controls a transaction. The controlling unit 1901 includes a starting unit 1903, a completing unit 1905, and a cancelling unit 1907. The starting unit 1903 executes a process of starting the transaction. The completing unit 1905 executes a process of completing the transaction. The cancelling unit 1907 executes a process of cancelling the transaction.

The operating unit 1911 handles records included in the table. The operating unit 1911 includes a first extracting unit 1913, an inserting unit 1915, a deleting unit 1917, an updating unit 1919, and a determining unit 1921. The first extracting unit 1913 executes the record extraction process. The inserting unit 1915 executes the record insertion process. The deleting unit 1917 executes a record deletion process. The updating unit 1919 executes the record update process. The determining unit 1921 executes a pattern determination process.

The controlling unit 1901, the starting unit 1903, the completing unit 1905, the cancelling unit 1907, the operating unit 1911, the first extracting unit 1913, the inserting unit 1915, the deleting unit 1917, the updating unit 1919, and the determining unit 1921 that are described above are achieved using hardware resources (for example, the hardware resources illustrated in FIG. 42) and the program that causes the processor to execute the following process.

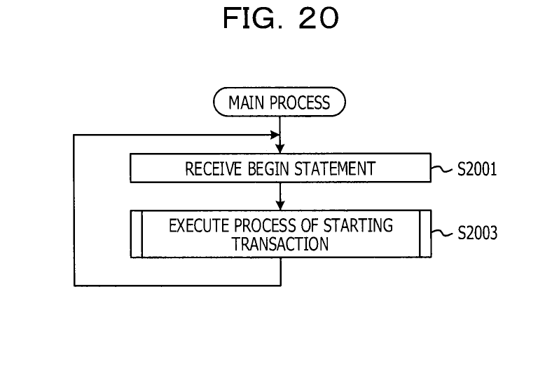

Next, a process to be executed by the executing unit 205 is described. FIG. 20 is a flowchart of the main process to be executed by the executing unit 205. The first receiving unit 203 receives a BEGIN statement (in S2001). When first receiving unit 203 receives the BEGIN statement, the starting unit 1903 executes the process of starting a transaction (in S2003).

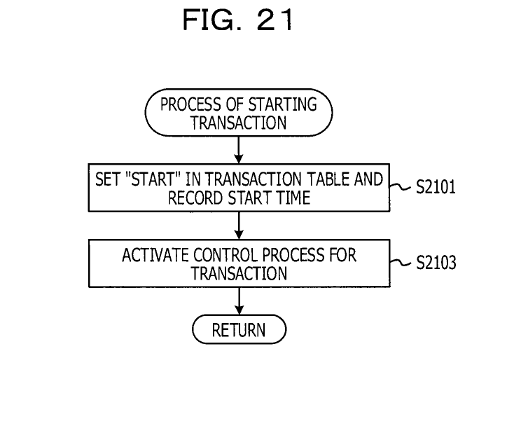

FIG. 21 is a flowchart of the process of starting the transaction. The starting unit 1903 provides a record for the interested transaction in the transaction table, sets “start” in the record for the interested transaction in the status field, and sets the current time in the record for the transaction in the start time field (in S2101). Then, the starting unit 1903 activates a control process for the transaction (in S2103). When the control process for the transaction is activated, the starting unit 1903 terminates the process of starting the transaction without waiting for the termination of the control process for the transaction. Then, the process returns to S2001 illustrated in FIG. 20.

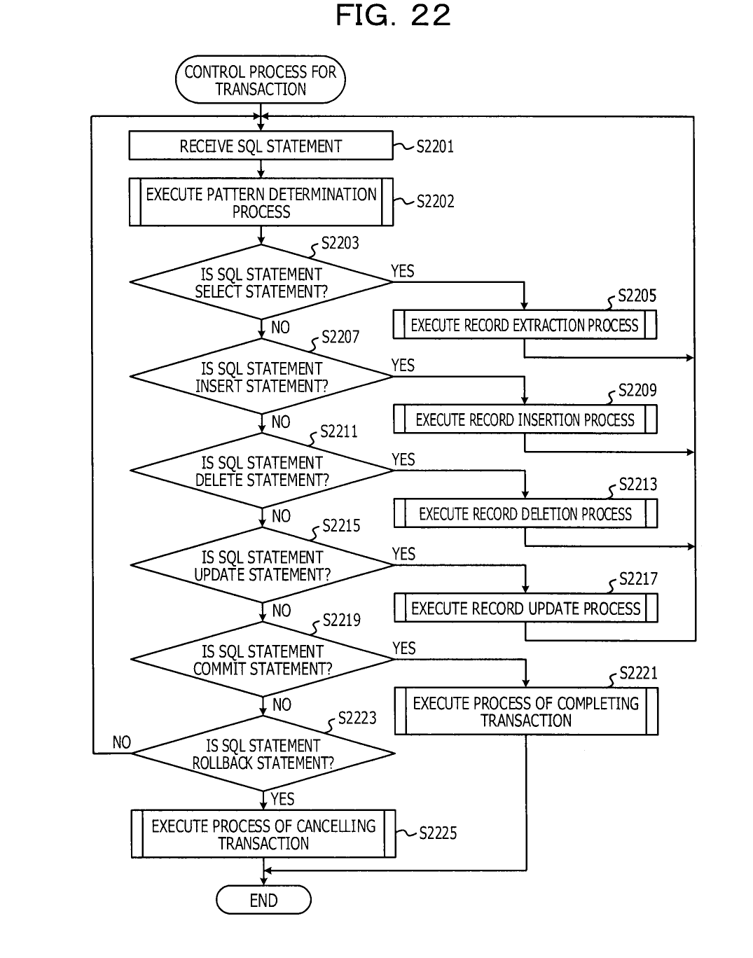

Next, the control process for the transaction is described. FIG. 22 is a flowchart of the control process for the transaction. The first receiving unit 203 receives an SQL statement 601 related to the interested transaction (in S2201).

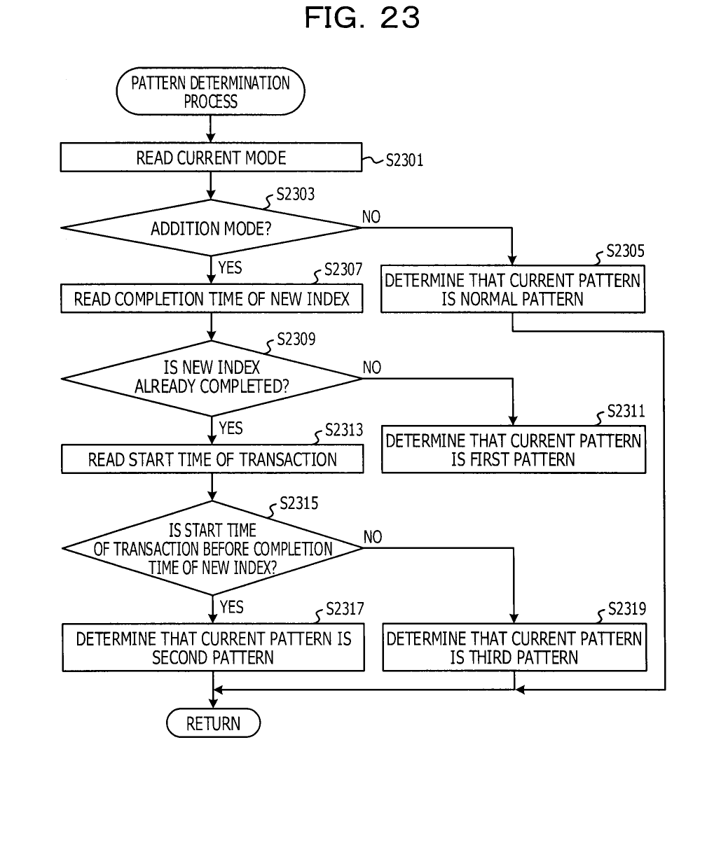

Then, the determining unit 1921 executes the pattern determination process (in S2202). FIG. 23 is a flowchart of the pattern determination process. The determining unit 1921 reads the current mode 1801 from the control data storage unit 1609 (in S2301). The determining unit 1921 determines whether or not the current mode 1801 is the “addition mode” (in S2303).

If the determining unit 1921 determines that the current mode 1801 is not the “addition mode” or if the current mode 1801 is the “normal mode”, the determining unit 1921 determines that the current pattern is the normal pattern (in S2305). Then, the pattern determination process is terminated and the process returns to a process of S2203 illustrated in FIG. 22.

On the other hand, if the determining unit 1921 determines that the current mode 1801 is the “addition mode”, the determining unit 1921 reads the completion time 1809 of the new index from the control data storage unit 1609 (in S2307). Then, the determining unit 1921 determines whether or not the new index is completed (in S2309). Specifically, the determining unit 1921 determines that the new index is completed if the completion time 1809 of the new index is set. If the completion time 1809 of the new index is yet to be set, the determining unit 1921 determines that the new index is yet to be completed.

If the determining unit 1921 determines that the new index is yet to be completed, the determining unit 1921 determines that the current pattern is the first pattern (in S2311). Then, the pattern determination process is terminated and the process returns to the process of S2203 illustrated in FIG. 22.

On the other hand, if the determining unit 1921 determines that the new index is already completed in S2309, the determining unit 1921 reads the start time of the interested transaction from the transaction table storage unit 1605 (in S2313). Then, the determining unit 1921 determines whether or not the start time of the interested transaction is before the completion time 1809 of the new index (in S2315).

If the determining unit 1921 determines that the start time of the interested transaction is before the completion time 1809 of the new index, the determining unit 1921 determines that the current pattern is the second pattern (in S2317). Then, the pattern determination process is terminated and the process returns to the process of S2203 illustrated in FIG. 22.

On the other hand, if the determining unit 1921 determines that the start time of the transaction is not before the completion time 1809 of the new index in S2315 or if the start time of the transaction is after the completion time 1809 of the new index, the determining unit 1921 determines that the current pattern is the third pattern (in S2319). Then, the pattern determination process is terminated and the process returns to the process of S2203 illustrated in FIG. 22.

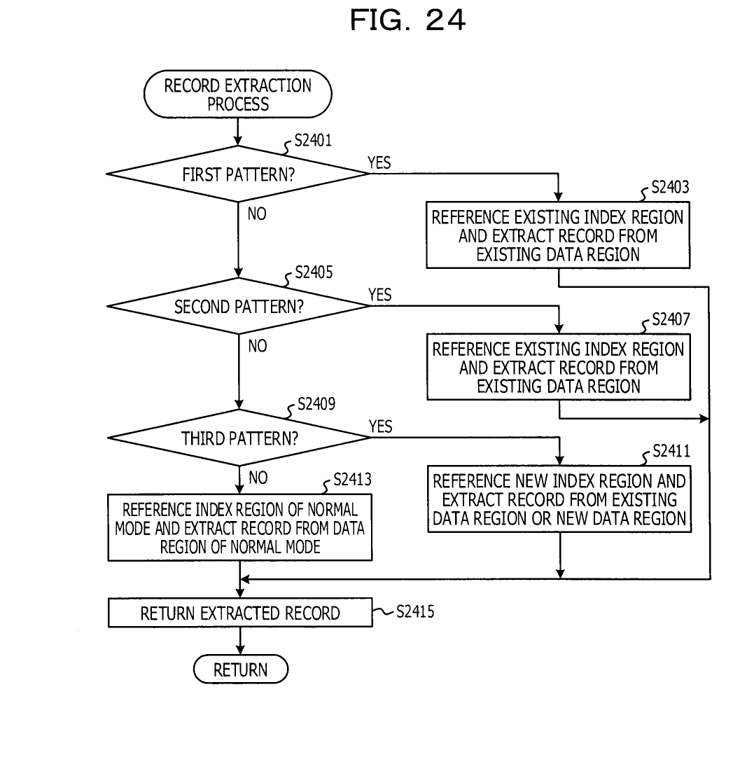

Return to the description of FIG. 22. The first extracting unit 1913 determines whether or not the received SQL statement 601 is a SELECT statement (in S2203). If the first extracting unit 1913 determines that the received SQL statement 601 is the SELECT statement, the first extracting unit 1913 executes the record extraction process (in S2205). The record extraction process is described later with reference to FIG. 24. When the record extraction process is terminated, the process returns to the process of S2201.

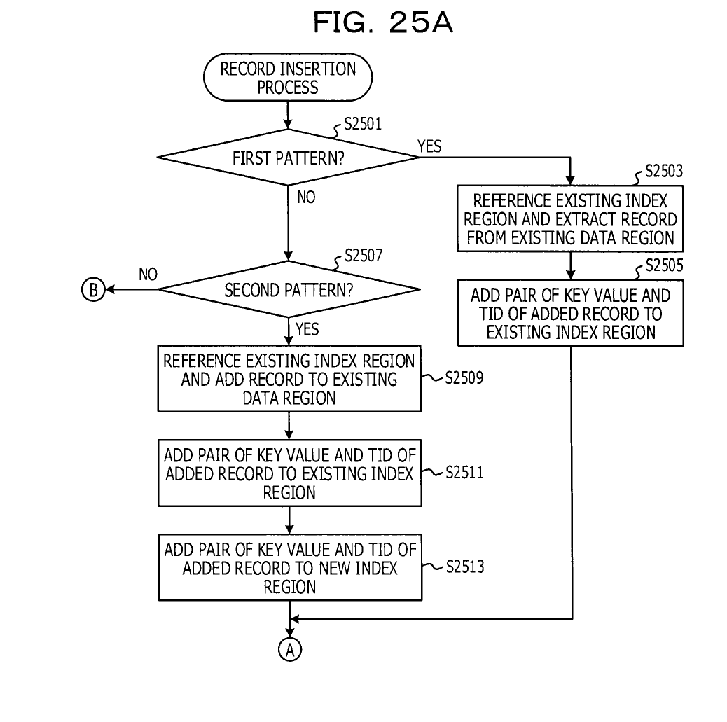

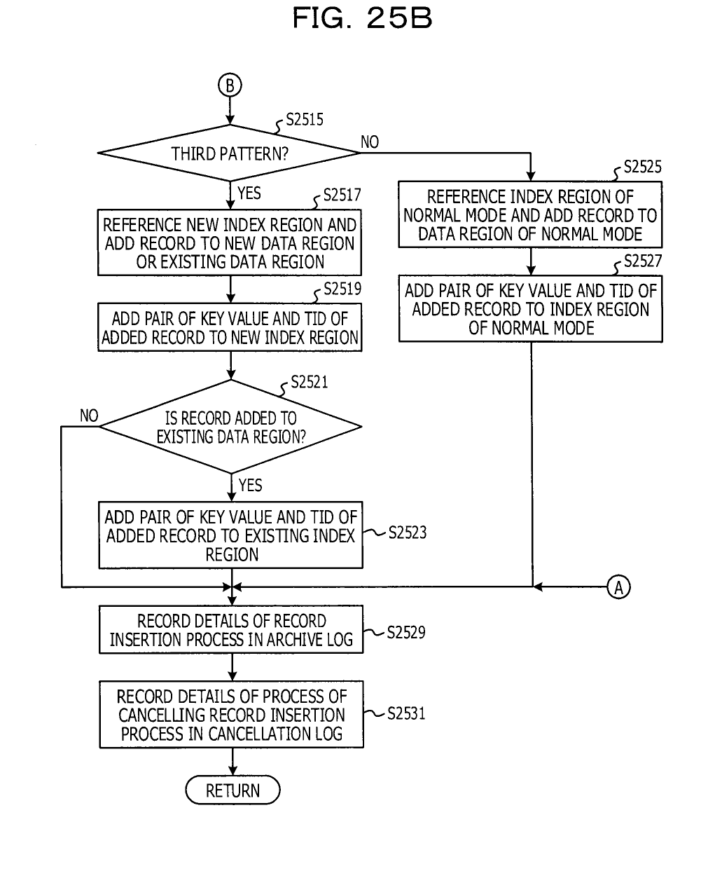

On the other hand, if the first extracting unit 1913 determines that the received SQL statement 601 is not the SELECT statement, the inserting unit 1915 determines whether or not the received SQL 601 is an INSERT statement (in S2207). If the inserting unit 1915 determines that the received SQL 601 is the INSERT statement, the inserting unit 1915 executes the record insertion process (in S2209). The record insertion process is described later with reference to FIGS. 25A and 25B. When the record insertion process is terminated, the process returns to the process of S2201.

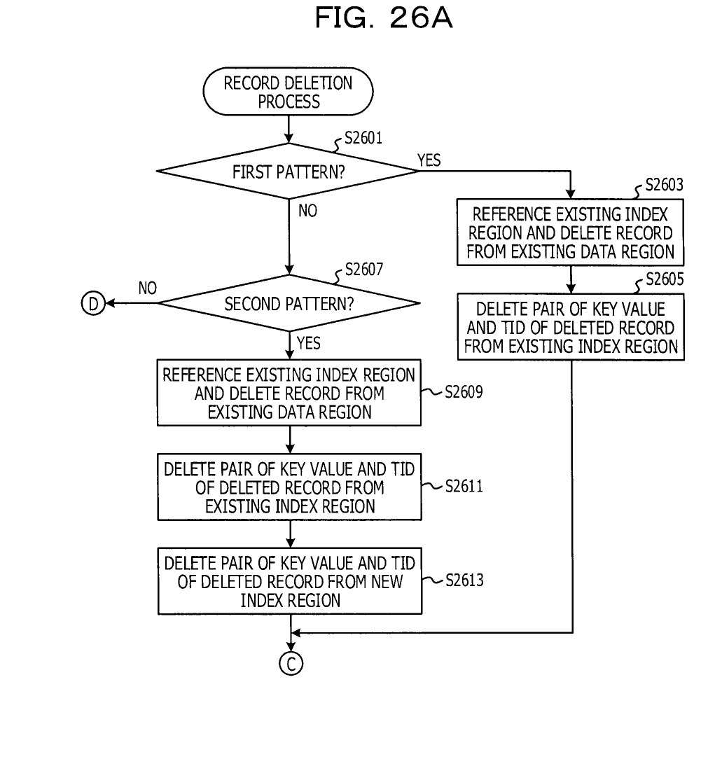

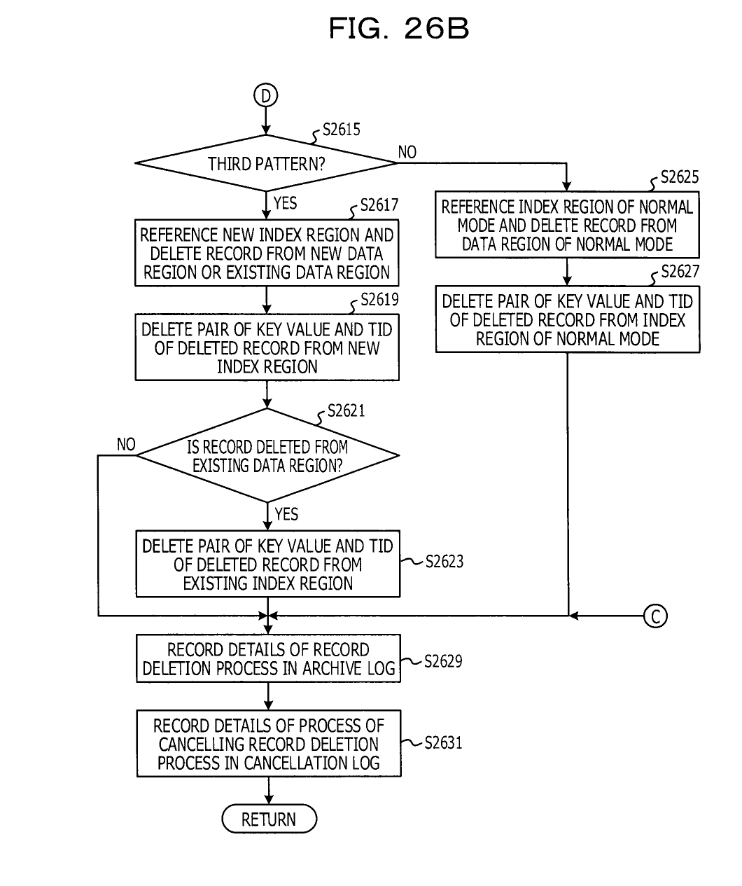

On the other hand, if the inserting unit 1915 determines that the received SQL statement 601 is not the INSERT statement, the deleting unit 1917 determines whether or not the received SQL statement 601 is a DELETE statement (in S2211). If the deleting unit 1917 determines that the received SQL statement 601 is the DELETE statement, the deleting unit 1917 executes the record deletion process (in S2213). The record deletion process is described later with reference to FIGS. 26A and 26B. When the record deletion process is terminated, the process returns to the process of S2201.

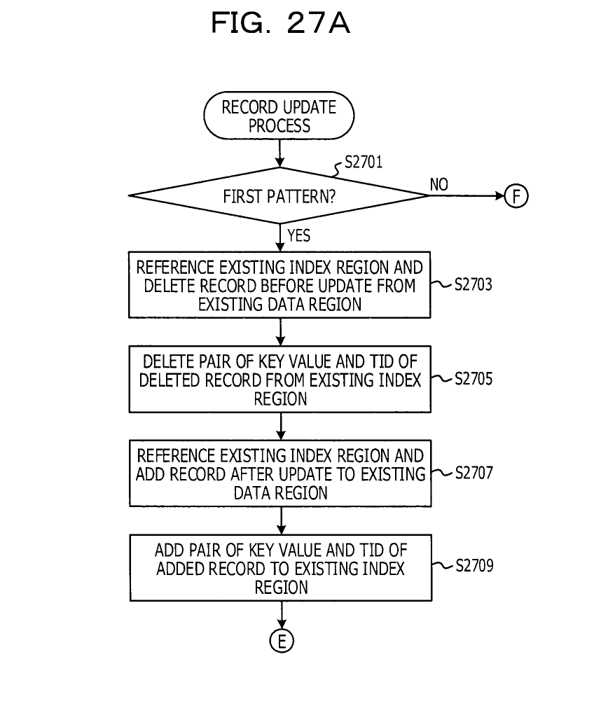

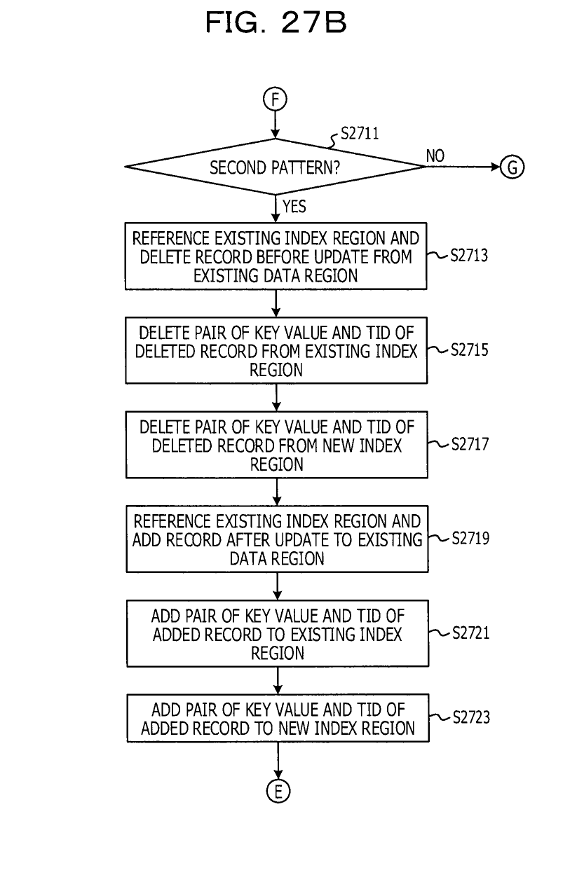

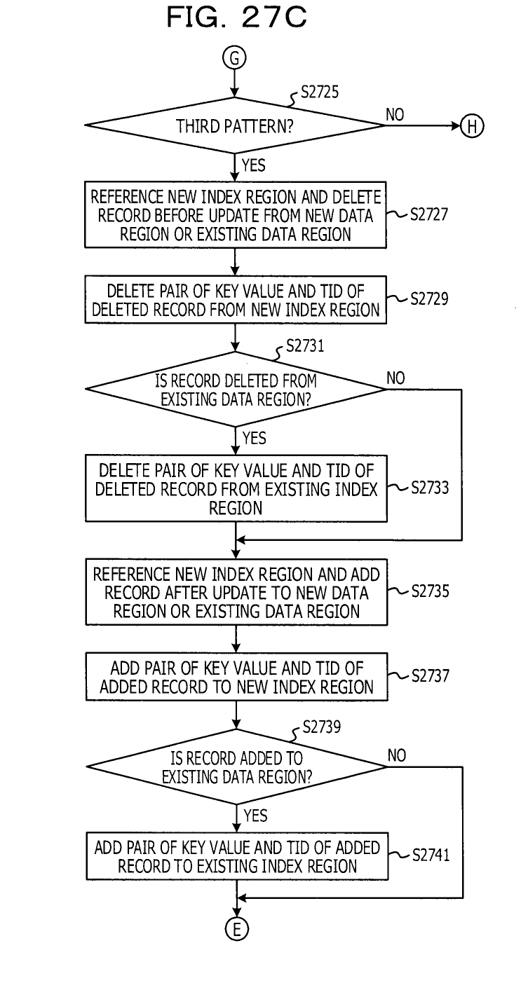

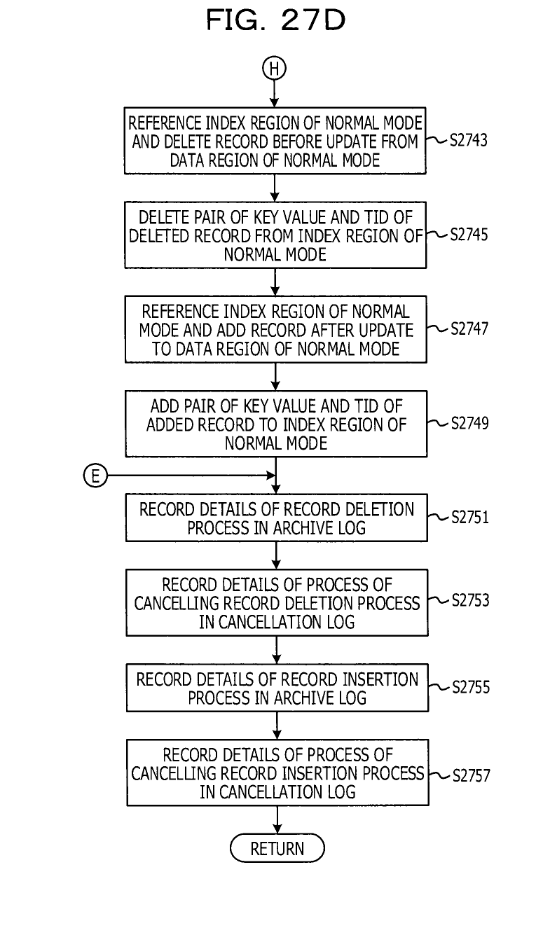

On the other hand, if the deleting unit 1917 determines that the received SQL statement 601 is not the DELETE statement, the updating unit 1919 determines whether or not the received SQL statement 601 is an UPDATE statement (in S2215). If the updating unit 1919 determines that the received SQL statement 601 is the UPDATE statement, the updating unit 1919 executes the record update process (in S2217). The record update process is described later with reference to FIGS. 27A to 27D. When the record update process is terminated, the process returns to the process of S2201.

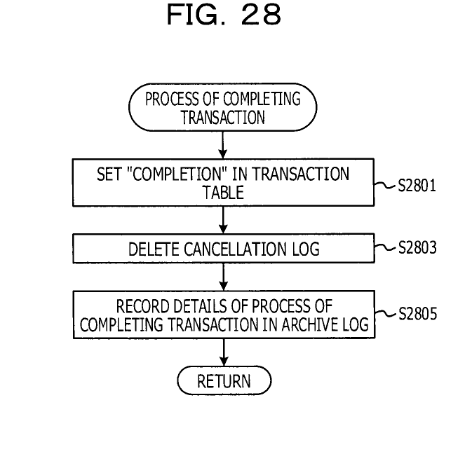

On the other hand, if the updating unit 1919 determines that the received SQL statement 601 is not the UPDATE statement, the completing unit 1905 determines whether or not the received SQL statement 601 is a COMMIT statement (in S2219). If the completing unit 1905 determines that the received SQL statement 601 is the COMMIT statement, the completing unit 1905 executes the process of completing the transaction (in S2221). The process of completing the transaction is described with reference to FIG. 28. When the process of completing the transaction is terminated, the control process for the transaction is terminated.

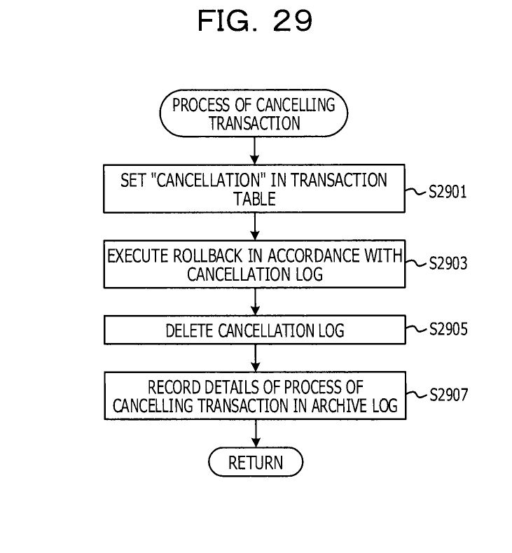

On the other hand, if the completing unit 1905 determines that the received SQL statement 601 is not the COMMIT statement, the cancelling unit 1907 determines whether or not the received SQL statement 601 is a ROLLBACK statement (in S2223). If the cancelling unit 1907 determines that the received SQL statement 601 is the ROLLBACK statement, the cancelling unit 1907 executes the process of cancelling the transaction (in S2225). The process of cancelling the transaction is described later with reference to FIG. 29. When the process of cancelling the transaction is terminated, the control process for the transaction is terminated.

On the other hand, if the cancelling unit 1907 determines that the received SQL statement 601 is not the ROLLBACK statement, the process returns to the process of S2201 in this example.

Next, the record extraction process is described. FIG. 24 is a flowchart of the record extraction process. The process by the first extracting unit 1913 is branched based on whether or not the current pattern is determined to be the first pattern in the pattern determination process of S2202 illustrated in FIG. 22 (in S2401). If the current pattern is determined to be the first pattern, the first extracting unit 1913 references the existing index region 701 and extracts a record from the existing data region 505 (in S2403). Then, the first extracting unit 1913 returns the extracted record to the application unit 109 (in S2415).

On the other hand, if the current pattern is determined not to be the first pattern, the process by the first extracting unit 1913 is branched based on whether or not the current pattern is determined to be the second pattern in the pattern determination process of S2202 illustrated in FIG. 22 (in S2405). If the current pattern is determined to be the second pattern, the first extracting unit 1913 references the existing index region 701 and extracts the record from the existing data region 505 (in S2407). Then, the first extracting unit 1913 returns the extracted record to the application unit 109 (in S2415).

On the other hand, if the current pattern is determined not to be the second pattern, the process by the first extracting unit 1913 is branched based on whether or not the current pattern is determined to be the third pattern in the pattern determination process of S2202 illustrated in FIG. 22 (in S2409). If the current pattern is determined to be the third pattern, the first extracting unit 1913 references the new index region 503 and extracts the record from the existing data region 505 or the new data region 501 (in S2411). In this case, the existing data region 505 or the new data region 501 is identified in accordance with a TID, for example. Then, the first extracting unit 1913 returns the extracted record to the application unit 109 (in S2415).

If the current pattern is determined not to be the third pattern or is determined to be the normal pattern in the pattern determination process of S2202 illustrated in FIG. 22, the first extracting unit 1913 references the index region of the normal mode and extracts the record from the data region of the normal mode (in S2413). Then, the first extracting unit 1913 returns the extracted record to the application unit 109 (in S2415).

When the extracted record is returned to the application unit 109, the record extraction process is terminated.

Next, the record insertion process is described. FIGS. 25A and 25B are flowcharts of the record insertion process. The process by the inserting unit 1915 is branched based on whether or not the current pattern is determined to be the first pattern in the pattern determination process of S2202 illustrated in FIG. 22 (in S2501). If the current pattern is determined to be the first pattern, the inserting unit 1915 references the existing index region 701 and adds a record to the existing data region 505 (in S2503). Then, the inserting unit 1915 adds, to the existing index region 701, a node that holds a pair of a key value and TID of the added record (in S2505). Then, the process proceeds to a process of S2529 illustrated in FIG. 25B through a terminal A.

On the other hand, if the current pattern is determined not to be the first pattern, the process by the inserting unit 1915 is branched based on whether or not the current pattern is determined to be the second pattern in the pattern determination process of S2202 illustrated in FIG. 22 (in S2507). If the current pattern is determined to be the second pattern, the inserting unit 1915 references the existing index region 701 and adds the record to the existing data region 505 (in S2509). Then, the inserting unit 1915 adds, to the existing index region 701, the node that holds the pair of the key value and TID of the added record (in S2511). In addition, the inserting unit 1915 adds, to the new index region 503, the node that holds the pair of the key value and TID of the added record (in S2513). Then, the process proceeds to the process of S2529 illustrated in FIG. 25B through the terminal A.

On the other hand, if the current pattern is determined not to be the second pattern, the process proceeds to a process of S2515 illustrated in FIG. 25B through a terminal B. The process by the inserting unit 1915 is branched based on whether or not the current pattern is determined to be the third pattern in the pattern determination process of S2202 illustrated in FIG. 22 (in S2515). If the current pattern is determined to be the third pattern, the inserting unit 1915 references the new index region 503 and adds the record to the new data region 501 or the existing data region 505 (in S2517). In this case, the existing data region 505 or the new data region 501 is identified in accordance with the TID, for example. The inserting unit 1915 adds, to the new index region 503, the node that holds the pair of the key value and TID of the added record (in S2519). Then, the inserting unit 1915 determines whether or not the record is added to the existing data region 505 (in S2521). If the inserting unit 1915 determines that the record is added to the existing data region 505, the inserting unit 1915 adds, to the existing index region 701, the node that holds the pair of the key value and TID of the added record (in S2523). On the other hand, if the record is not added to the existing data region 505 or if the record is added to the new data region 501, the node is not added to the existing index region 701. Then, the process proceeds to the process of S2529.

Return to the description of the branch in S2515. If the current pattern is determined not to be the third pattern or if the current pattern is determined to be the normal pattern in the pattern determination process of S2202 illustrated in FIG. 22, the inserting unit 1915 references the index region of the normal mode and adds the record to the data region of the normal mode (in S2525). Then, the inserting unit 1915 adds, to the index region of the normal mode, the node that holds the pair of the key value and TID of the added record (in S2527).

As described above, when the addition of the record and the addition of the node in any of the patterns are terminated, the recording processing unit 215 records details of the record insertion process in the archive log 707 (in S2529). The data recorded in S2529 is the pair of the key value and TID of the added record and “insertion” as a node operation type. The recording processing unit 215 records details of the process of cancelling the record insertion process in the cancellation log (in S2531). The data recorded in S2531 is the pair of the key value and TID of the added record and “deletion” as a node operation type.

Next, the record deletion process is described. FIGS. 26A and 16B are flowchart of the record deletion process. The process by the deleting unit 1917 is branched based on whether or not the current pattern is determined to be the first pattern in the pattern determination process of S2202 illustrated in FIG. 22 (in S2601). If the current pattern is determined to be the first pattern, the deleting unit 1917 references the existing index region 701 and deletes the record from the existing data region 505 (in S2603). Then, the deleting unit 1917 deletes, from the existing index region 701, the node that holds the pair of the key value and TID of the deleted record (in S2605). Then, the process proceeds to a process of S2629 illustrated in FIG. 26B through a terminal C.

On the other hand, if the current pattern is determined not to be the first pattern, the process by the deleting unit 1917 is branched based on whether or not the current pattern is determined to be the second pattern in the pattern determination process of S2202 illustrated in FIG. 22 (in S2607). If the current pattern is determined to be the second pattern, the deleting unit 1917 references the existing index region 701 and deletes the record from the existing data region 505 (in S2609). Then, the deleting unit 1917 deletes, from the existing index region 701, the node that holds the key value and TID of the deleted record (in S2611). In addition, the deleting unit 1917 deletes, from the new index region 503, the node that holds the pair of the key value and TID of the deleted record (in S2613). Then, the process proceeds to the process of S2629 illustrated in FIG. 26B through the terminal C.

On the other hand, if the current pattern is determined not to be the second pattern, the process proceeds to the process of S2615 illustrated in FIG. 26B through a terminal D. The process by the deleting unit 1917 is branched based on whether or not the current pattern is determined to be the third pattern in the pattern determination process of S2202 illustrated in FIG. 22 (in S2615). If the current pattern is determined to be the third pattern, the deleting unit 1917 references the new index region 503 and deletes the record from the new data region 501 or the existing data region 505 (in S2617). In this case, the existing data region 505 or the new data region 501 is identified in accordance with the TID, for example. The deleting unit 1917 deletes, from the new index region 503, the node that holds the pair of the key value and TID of the deleted record (in S2619). Then, the deleting unit 1917 determines whether or not the record is deleted from the existing data region 505 (in S2621). If the deleting unit 1917 determines that the record is deleted from the existing data region 505, the deleting unit 1917 deletes, from the existing index region 701, the node that holds the pair of the key value and TID of the deleted record (in S2623). On the other hand, if the deleting unit 1917 determines that the record is not deleted from the existing data region 505 or if the record is deleted from the new data region 501, the node is not deleted from the existing index region 701. Then, the process proceeds to the process of S2629.

Return to the description of the branch in S2615. If the current pattern is determined not to be the third pattern or if the current pattern is determined to be the normal pattern in the pattern determination process of S2202 illustrated in FIG. 22, the deleting unit 1917 references the index region of the normal mode and deletes the record from the data region of the normal mode (in S2625). Then, the deleting unit 1917 deletes, from the index region of the normal mode, the node that holds the pair of the key value and TID of the deleted record (in S2627).

As described above, when the deletion of the record and the deletion of the node in any of the patterns are terminated, the recording processing unit 215 records details of the record deletion process in the archive log 707 (in S2629). The data recorded in S2629 is the pair of the key value and TID of the deleted record and “deletion” as a node operation type. The recording processing unit 215 records details of the process of cancelling the record deletion process in the cancellation log (in S2631). The data recorded in S2631 is the pair of the key value and TID of the deleted record and “insertion” as a node operation type.

Next, the record update process is described. FIGS. 27A to 27D are flowchart of the record update process. The process by the updating unit 1919 is branched based on whether or not the current pattern is determined to be the first pattern in the pattern determination process of S2202 illustrated in FIG. 22 (in S2701). If the current pattern is determined to be the first pattern, the updating unit 1919 references the existing index region 701 and deletes the record before update from the existing data region 505 (in S2703). The updating unit 1919 deletes, from the existing index region 701, the node that holds the pair of the key value and TID of the deleted record (in S2705). In addition, the updating unit 1919 references the existing index region 701 and adds the record after the update to the existing data region 505 (in S2707). Then, the updating unit 1919 adds, to the existing index region 701, the node that holds the pair of the key value and TID of the added record (in S2709). Then, the process proceeds to a process of S2751 illustrated in FIG. 27D through a terminal E.

Return to the description of the branch in S2701. If the current pattern is determined not to be the first pattern, the process proceeds to a process of S2711 illustrated in FIG. 27B. The process by the updating unit 1919 is branched based on whether or not the current pattern is determined to be the second pattern in the pattern determination process of S2202 illustrated in FIG. 22 (in S2711). If the current pattern is determined to be the second pattern, the updating unit 1919 references the existing index region 701 and deletes the record before the update from the existing data region 505 (in S2713). The updating unit 1919 deletes, from the existing index region 701, the node that holds the pair of the key value and TID of the deleted record (in S2715). In addition, the updating unit 1919 deletes, from the new index region 503, the node that holds the pair of the key value and TID of the deleted record (in S2717). In addition, the updating unit 1919 references the existing index region 701 and adds the record after the update to the existing data region 505 (in S2719). The updating unit 1919 adds, to the existing index region 701, the node that holds the pair of the key value and TID of the added record (in S2721). Then, the updating unit 1919 adds, to the new index region 503, the node that holds the pair of the key value and TID of the added record (in S2723). Then, the process proceeds to a process of S2751 illustrated in FIG. 27D through the terminal E.

Return to the description of the branch in S2711. If the current pattern is determined not to be the second pattern, the process proceeds to a process of S2725 illustrated in FIG. 27C through a terminal G. The process by the updating unit 1919 is branched based on whether or not the current pattern is determined to be the third pattern in the pattern determination process of S2202 illustrated in FIG. 22 (in S2725). If the current pattern is determined to be the third pattern, the updating unit 1919 references the new index region 503 and deletes the record before the update from the new data region 501 or the existing data region 505 (in S2727). In this case, the existing data region 505 or the new data region 501 is identified based on the TID, for example. The updating unit 1919 deletes, from the new index region 503, the node that holds the pair of the key value and TID of the deleted record (in S2729). Then, the updating unit 1919 determines whether or not the record is deleted from the existing data region 505 (in S2731). If the updating unit 1919 determines that the record is deleted from the existing data region 505, the updating unit 1919 deletes, from the existing index region 701, the node that holds the pair of the key value and TID of the deleted record (in S2733). On the other hand, if the updating unit 1919 determines that the record is not deleted from the existing data region 505 or if the record is deleted from the new data region 501, the node is not deleted from the existing index region 701.

In addition, the updating unit 1919 references the new index region 503 and adds the record after the update to the new data region 501 or the existing data region 505 (in S2735). In this case, the existing data region 505 or the new data region 501 is identified in accordance with the TID, for example. The updating unit 1919 adds, to the new index region 503, the node that holds the pair of the key value and TID of the added record (in S2737). Then, the updating unit 1919 determines whether or not the record is added to the existing data region 505 (in S2739). If the updating unit 1919 determines that the record is added to the existing data region 505, the updating unit 1919 adds, to the existing index region 701, the node that holds the pair of the key value and TID of the added record (in S2741). On the other hand, if the updating unit 1919 determines that the record is not added to the existing data region 505 or if the record is added to the new data region 501, the node is not added to the existing index region 701. Then, the process proceeds to a process of S2751 illustrated in FIG. 27D through the terminal E.

Return to the description of the branch in S2725. If the current pattern is determined not to be the third pattern or if the current pattern is determined to be the normal pattern in the pattern determination process of S2202 illustrated in FIG. 22, the process proceeds to a process of S2743 illustrated in FIG. 22D through a terminal H.

The updating unit 1919 references the index region of the normal mode and deletes the record before the update from the data region of the normal mode (in S2743). The updating unit 1919 deletes, from the index region of the normal mode, the node that holds the pair of the key value and TID of the deleted record (in S2745). The updating unit 1919 references the index region of the normal mode and adds the record after the update to the data region of the normal mode (in S2747). The updating unit 1919 adds, to the index region of the normal mode, the node that holds the pair of the key value and TID of the added record (in S2749).

As described above, when the deletion of the record, the deletion of the node, the addition of the record, and the addition of the node in any of the patterns are terminated, the recording processing unit 215 records details of the record deletion process in the archive log 707 (in S2751). The data recorded in S2751 is the pair of the key value and TID of the deleted record and “deletion” as a node operation type”. The recording processing unit 215 records details of the process of cancelling the record deletion process in the cancellation log (in S2753). The data recorded in S2753 is the pair of the key value and TID of the deleted record and “insertion” as a node operation type. The recording processing unit 215 records details of the record insertion process in the archive log 707 (in S2755). The data recorded in S2755 is the pair of the key value and TID of the added record and “insertion” as a node operation type. The recording processing unit 215 records details of the process of cancelling the record insertion process in the cancellation log (in S2757). The data recorded in S2757 is the pair of the key value and TID of the added record and “deletion” as a node operation type.

Next, the process of completing the transaction is described. FIG. 28 is a flowchart of the process of completing the transaction. The completing unit 1905 identifies the record of the transaction to be completed from the transaction table and sets “completion” in the interested record in the status field (in S2801). The recording processing unit 215 deletes the cancellation log of the interested transaction (in S2803). This is due to the fact that a rollback of the interested transaction is not executed after the completion of the transaction. Then, the recording processing unit 215 records details of the process of completing the transaction in the archive log 707 (in S2805). When the process of completing the transaction is terminated, the control process (illustrated in FIG. 22) for the transaction is terminated.

Next, the process of cancelling the transaction is described. FIG. 29 is a flowchart of the process of cancelling the transaction. The cancelling unit 1907 identifies the record of the transaction to be cancelled from the transaction table and sets “cancellation” in the identified record in the status field (in S2901). The cancelling unit 1907 executes the rollback in accordance with the cancellation log (in S2903). The cancelling unit 1907 deletes the cancellation log (in S2905). Then, the cancelling unit 1907 records details of the process of cancelling the transaction in the archive log 707 (in S2907). When the process of cancelling the transaction is terminated, the control process (illustrated in FIG. 22) for the transaction is terminated. The description of the executing unit 205 is finished.

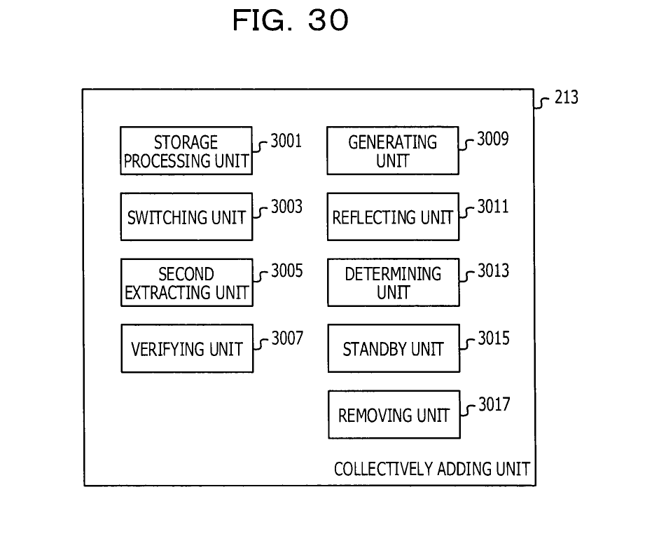

Next, the collectively adding unit 213 is described. FIG. 30 illustrates an example of the configuration of the collectively adding unit 213. The collectively adding unit 213 includes a storage processing unit 3001, a switching unit 3003, a second extracting unit 3005, a verifying unit 3007, a generating unit 3009, a reflecting unit 3011, a determining unit 3013, a standby unit 3015, and a removing unit 3017.

The storage processing unit 3001 stores the added data in the added data region 507, for example. The switching unit 3003 switches between the modes. The second extracting unit 3005 extracts the element string 709 from the added data. The verifying unit 3007 verifies the uniqueness of the database, for example. The generating unit 3009 executes the generation process. The reflecting unit 3011 executes the reflection process. The determining unit 3013 determines the time when a new index is completed. The standby unit 3015 executes the standby process. The removing unit 3017 removes unwanted data.

The storage processing unit 3001, the switching unit 3003, the second extracting unit 3005, the verifying unit 3007, the generating unit 3009, the reflecting unit 3011, the determining unit 3013, the standby unit 3015, and the removing unit 3017 are achieved using hardware resources (for example, the hardware resources illustrated in FIG. 42) and a program that causes the processor to execute the following process.

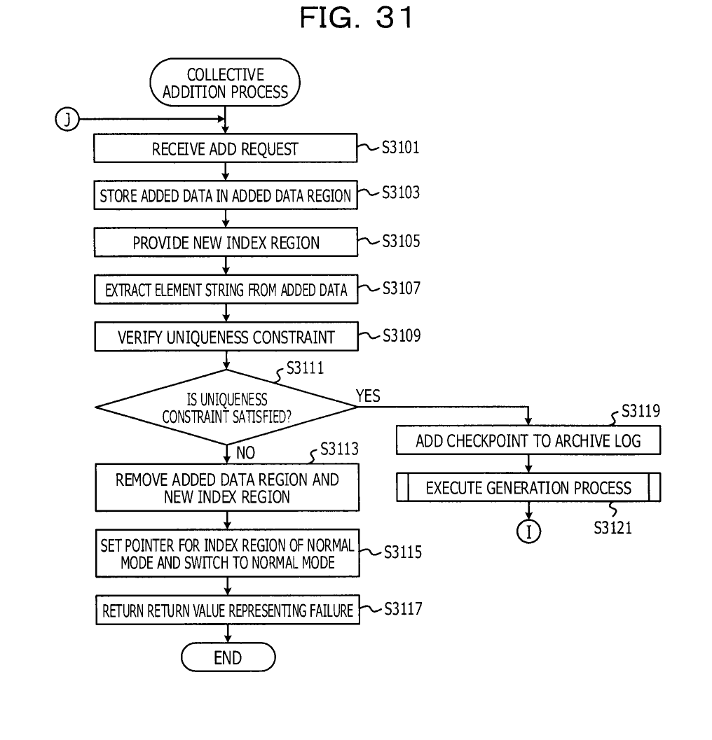

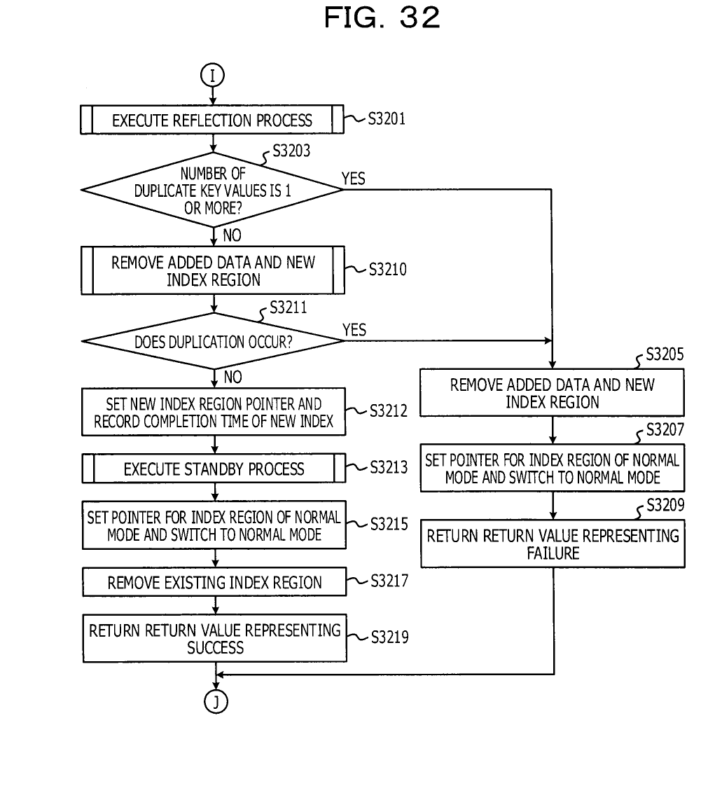

Next, the collective addition process to be executed by the collectively adding unit 213 is described. FIGS. 31 and 32 are flowchart of the collective addition process. The second receiving unit 211 receives the add request (in S3101). The storage processing unit 3001 stores the added data in the added data region 507 (in S3103). The added data described in this example includes a plurality of records to be added to the table of the database. The storage processing unit 3001 provides the new index region 503 (in S3104).

The switching unit 3003 switches the current mode to the addition mode (in S3105). In this case, the switching unit 3003 sets “addition mode” in the field for the current mode 1801 in the control data storage unit 1609. The second extracting unit 3005 extracts the element string 709 from the added data (in S3107). The elements extracted in this example include the pairs of the key values and TIDs that are to be added to the new leaf node region 509.

Then, the verifying unit 3007 verifies a uniqueness constraint for the added data (in S3109). Specifically, the verifying unit 3007 determines whether or not two or more of the key values included in the element string 709 are the same.

Then, the verifying unit 3007 determines whether or not the added data satisfies the uniqueness constraint (in S3111). If the element string 709 does not include two or more key values that are the same, the verifying unit 3007 determines that the added data satisfies the uniqueness constraint. On the other hand, if the element string 709 includes two or more key values that are the same, the verifying unit 3007 determines that the added data does not satisfy the uniqueness constraint.

If the verifying unit 3007 determines that the added data does not satisfy the uniqueness constraint, the removing unit 3017 removes the added data region 507 and the new index region 503 (in S3113). In this case, the removing unit 3017 also removes the element string 709. The switching unit 3003 sets the pointer 1803 provided for the index region of the normal mode and included in the control data storage unit 1609 and switches the current mode 1801 to the “normal mode” (in S3115). In this case, the existing index region pointer 1805 included in the control data storage unit 1609 is copied to the pointer 1803 provided for the index region of the normal mode and included in the control data storage unit 1609. The collectively adding unit 213 returns a return value representing a failure to the loader unit 107 (in S3117). Then, the collectively adding unit 213 terminates the collective addition process.

On the other hand, if the verifying unit 3007 determines that the added data satisfies the uniqueness constraint in S3111, the recording processing unit 215 adds a checkpoint to the archive log 707 stored in the archive log storage unit 1603 (in S3119). The checkpoint is used to identify a record after the time when the generation process is started.

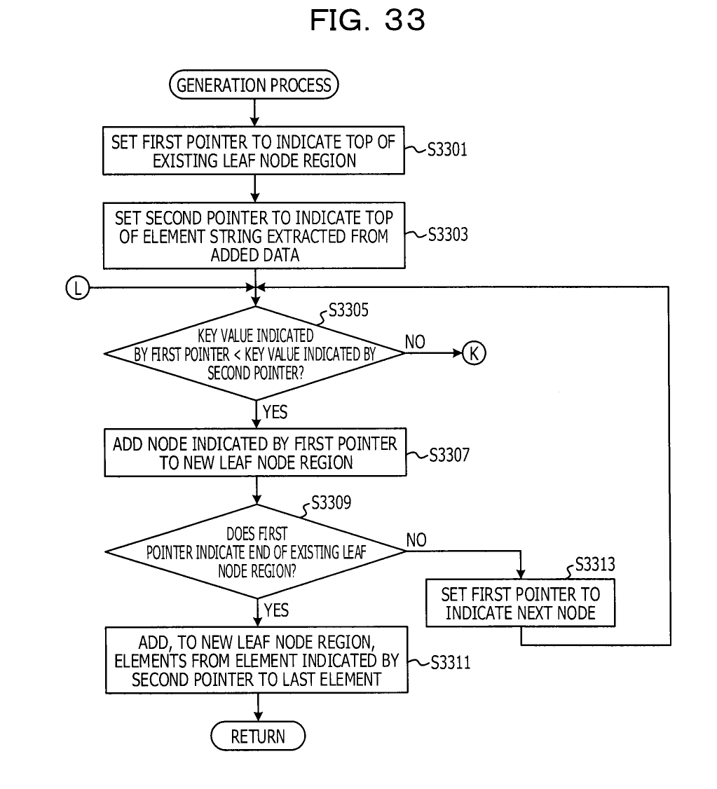

Then, the generating unit 3009 executes the generation process (in S3121). The generating unit 3009 merges the nodes of the existing leaf node region 703 with the elements of the element string 709 and generates the new leaf node region 509, as represented by S757 in FIG. 7. The generation process is described below with reference to FIGS. 33 to 35.

FIG. 33 is a flowchart of the generation process. The generating unit 3009 sets a first pointer to indicate the top (position of the first node) of the existing leaf node region 703 (in S3301). The first pointer is used to identify a node included in the existing leaf node region 703 and to be compared. The first pointer indicates the node and may be treated to indicate a key value of the node. The generating unit 3009 sets a second pointer to indicate the top (position of the first element) of the element string 709 extracted from the added data (in S3303). The second pointer is used to identify an element included in the element string 709 and to be compared. The second pointer indicates the element and may be treated to indicate a key value of the element.

The generating unit 3009 determines whether or not the key value indicated by the first pointer is smaller than the key value indicated by the second pointer (in S3305). If the generating unit 3009 determines that the key value indicated by the first pointer is smaller than the key value indicated by the second pointer, the generating unit 3009 adds the node indicated by the first pointer to the new leaf node region 509 (in S3307). Then, the generating unit 3009 determines whether or not the first pointer indicates the end (position of the last node) of the existing leaf node region 703 (in S3309).

If the generating unit 3009 determines that the first pointer indicates the end of the existing leaf node region 703, the generating unit 3009 treats, as a new node, elements from the element indicated by the second pointer to the last element and adds the new node to the new leaf node region 509 (in S3311). Then, the generation process is terminated and the process proceeds to a process of S3201 illustrated in FIG. 32 through a terminal I illustrated in FIG. 31.

On the other hand, if the generating unit 3009 determines that the first pointer does not indicate the end of the existing leaf node region 703 in S3309, the generating unit 3009 sets the first pointer to indicate the next node (in S3313). Then, the process returns to the process of S3305.

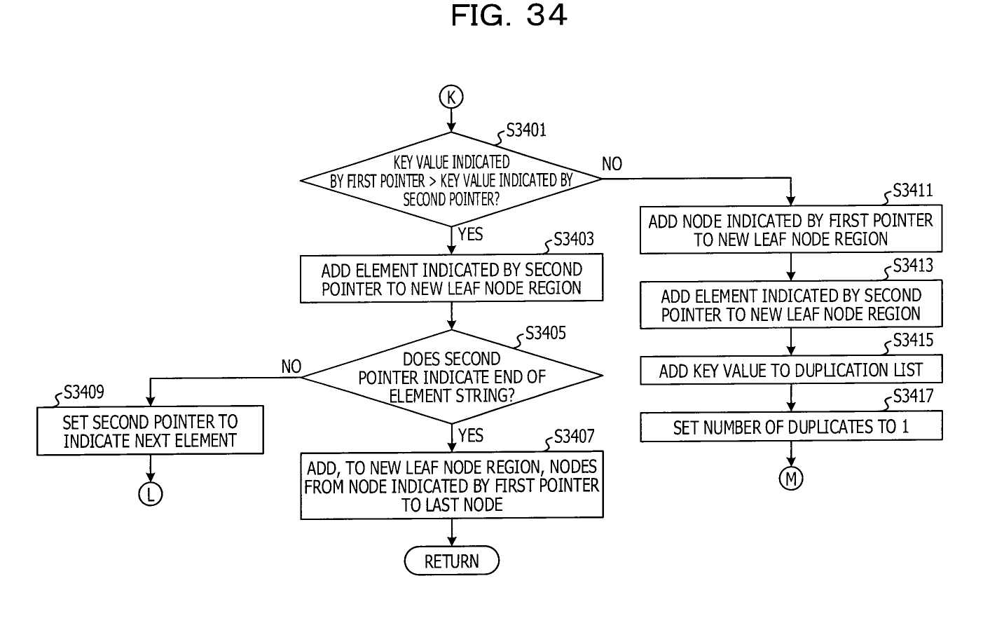

If the generating unit 3009 determines that the key value indicated by the first pointer is not smaller than the key value indicated by the second pointer in S3305, the process proceeds to a process of S3401 illustrated in FIG. 34 through a terminal K.

The generating unit 3009 determines whether or not the key value indicated by the second pointer is smaller than the key value indicated by the first pointer (in S3401). If the generating unit 3009 determines that the key value indicated by the second pointer is smaller than the key value indicated by the first pointer, the generating unit 3009 treats, as a new node, an element indicated by the second pointer and adds the new node to the new leaf node region 509 (in S3403). Then, the generating unit 3009 determines whether or not the second pointer indicates the end (position of the last element) of the element string 709 (in S3405).

If the generating unit 3009 determines that the second pointer indicates the end of the element string 709, the generating unit 3009 adds nodes from the node indicated by the first pointer to the last node to the new leaf node region 509 (in S3407). Then, the generation process is terminated and the process proceeds to the process of S3201 illustrated in FIG. 32 through the terminal I illustrated in FIG. 31.

On the other hand, if the generating unit 3009 determines that the second pointer does not indicate the end of the element string 709, the generating unit 3009 sets the second pointer to indicate the next element (in S3409). Then, the process returns to the process of S3305 illustrated in FIG. 33 through a terminal L.

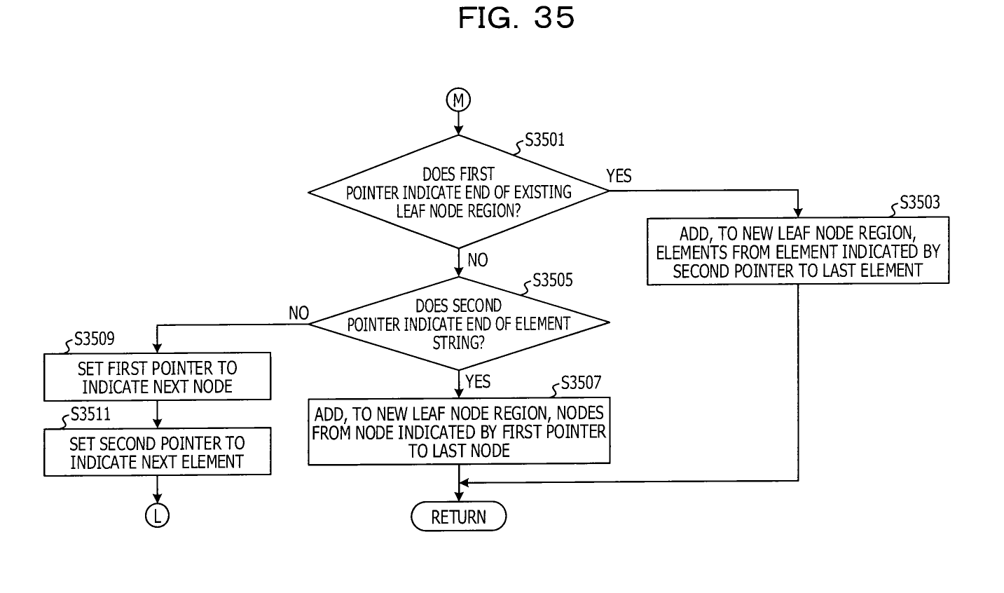

If the generating unit 3009 determines that the key value indicated by the second pointer is not smaller than the key value indicated by the first pointer in S3401 or if the key value indicated by the first pointer is equal to the key value indicated by the second pointer, the generating unit 3009 adds the node indicated by the first pointer to the new leaf node region 509 (in S3411). In addition, the generating unit 3009 treats, as a new node, the element indicated by the second pointer and adds the new node to the new leaf node region 509 (in S3413). Then, the generating unit 3009 adds the key value to the duplication list 1401 (in S3415). The generating unit 3009 sets the number of duplicates to 1 (in S3417). The duplication list 1401 is generated by the processes of S3415 and S3417, as illustrated in FIG. 14. The process proceeds to a process of S3501 illustrated in FIG. 35 through a terminal M.

Then, the generating unit 3009 determines whether or not the first pointer indicates the end of the existing leaf node region 703 (in S3501). If the generating unit 3009 determines that the first pointer indicates the end of the existing leaf node region 703, the generating unit 3009 treads, as a new node, elements from the element indicated by the second pointer to the last element and adds the new node to the new leaf node region 509 (in S3503). Then, the generation process is terminated and the process proceeds to the process of S3201 illustrated in FIG. 32 through the terminal I illustrated in FIG. 31.

On the other hand, if the generating unit 3009 determines that the first pointer does not indicate the end of the existing leaf node region 703 in S3501, the generating unit 3009 determines whether or not the second pointer indicates the end of the element string 709 (in S3505). If the generating unit 3009 determines that the second pointer indicates the end of the element string 709, the generating unit 3009 adds nodes from the node indicated by the first node to the last node to the new leaf node region 509 (in S3507). Then, the generation process is terminated and the process proceeds to the process of S3201 illustrated in FIG. 32 through the terminal I illustrated in FIG. 31.

If the generating unit 3009 determines that the second pointer does not indicate the end of the element string 709 in S3505, the generating unit 3009 sets the first pointer to indicate the next node (in S3509). In addition, the generating unit 3009 sets the second pointer to indicate the next element (in S3511). Then, the process returns to the process of S3305 illustrated in FIG. 33 through the terminal L.

As illustrated in FIG. 31, when the generation process (S3121) is terminated, the process proceeds to the process of S3201 illustrated in FIG. 32 through the terminal I.

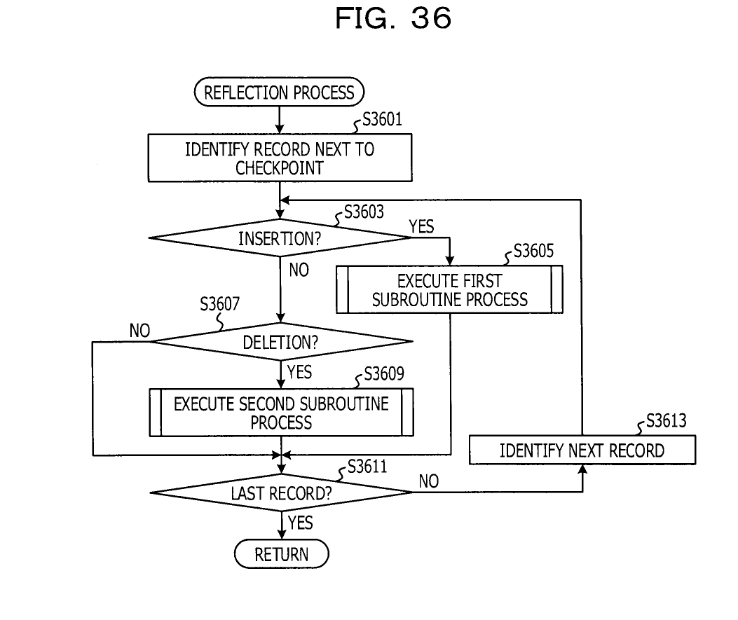

The reflecting unit 3011 executes the reflection process (in S3201). The reflecting unit 3011 applies the archive log 707 to the new leaf node region 509 in the reflection process, as represented by S759 in FIG. 7. The reflection process is described below with reference to FIGS. 36 to 38.

FIG. 36 is a flowchart of the reflection process. The reflecting unit 3011 identifies a record next to the checkpoint in the archive log 707 (in S3601). The reflecting unit 3011 determines whether or not a node operation type of the record identified in S3601 or S3613 is “insertion” (in S3603). If the reflecting unit 3011 determines that the node operation type of the identified record is “insertion”, the reflecting unit 3011 executes a first subroutine process (in S3605). The reflecting unit 3011 executes a process corresponding to the insertion of a record into the table of the database in the first subroutine process.

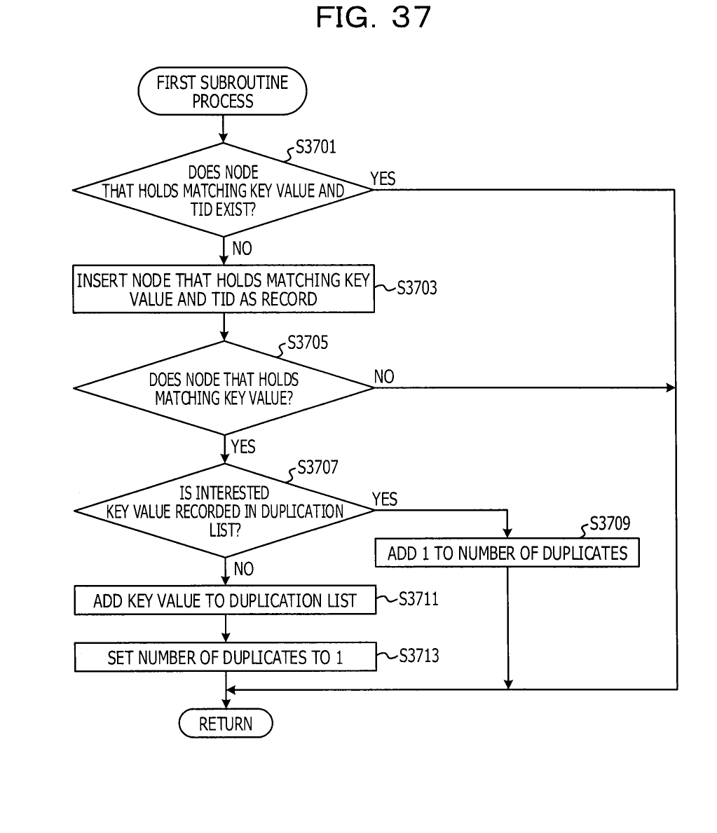

FIG. 37 is a flowchart of the first subroutine process. The reflecting unit 3011 determines whether or not a node that holds a key value and a TID that match a key value and TID of the record identified in S3601 or S3613 illustrated in FIG. 36 exists (in S3701). If the reflecting unit 3011 determines that the node that holds the key value and the TID that match the key value and TID of the identified record exists, the process corresponding to the insertion of the record into the table of the database is already terminated, the first subroutine process is terminated, and the process returns to the process of S3611 illustrated in FIG. 36. This process corresponds to handling of the record 903 having the key value “10” and TID “500” illustrated in FIG. 9, for example.

On the other hand, if the reflecting unit 3011 determines that the node that holds the key value and the TID that match the key value and TID of the identified record does not exist in S3701, the process corresponding to the insertion of the record into the table of the database is yet to be terminated, and the reflecting unit 3011 inserts a node having the same key value and TID as the record (in S3703). This process corresponds to handling of the record 901 illustrated in FIG. 9 and having the key value “7” and the TID “2000”, for example.

Then, the reflecting unit 3011 determines whether or not a node that holds a key value matching the key value of the identified record exists (in S3705). If the reflecting unit 3011 determines that the node that holds the key value matching the key value of the identified record does not exist, the key values are not duplicated, the first subroutine process is terminated, and the process returns to the process of S3611 illustrated in FIG. 36.

On the other hand, if the reflecting unit 3011 determines that the node that holds the key value matching the key value of the identified record exists, the key values are duplicated and recorded in the duplication list 1401. Thus, the reflecting unit 3011 determines whether or not the interested key value is already recorded in the duplication list 1401 (in S3707). If the reflecting unit 3011 determines that the interested key value is already recorded in the duplication list 1401, the reflecting unit 3011 adds 1 to the number of duplicates (in S3709).

On the other hand, if the reflecting unit 3011 determines that the interested key value is not recorded in the duplication list 1401, the reflecting unit 3011 adds the key value to the duplication list 1401 (in S3711) and sets, to 1, the number, corresponding to the interested key value, of duplicates (in S3713). The duplication list 1401 is updated by the processes of S3711 and S3713, as represented in the lower part of FIG. 15, for example. When the first subroutine process is terminated, the process returns to the process of S3611 illustrated in FIG. 36.

Return to the description of FIG. 36. The reflecting unit 3011 determines whether or not the node operation type of the record identified in S3601 or S3613 is “deletion” (in S3607). If the reflecting unit 3011 determines that the node operation type of the record identified in S3601 or S3613 is “deletion”, the reflecting unit 3011 executes a second subroutine process (in S3609). The reflecting unit 3011 executes a process corresponding to the deletion of a record from the table of the database in the second subroutine process. If the reflecting unit 3011 determines that the node operation type of the identified record is not “deletion” in S3607, the process proceeds to the process of S3611.

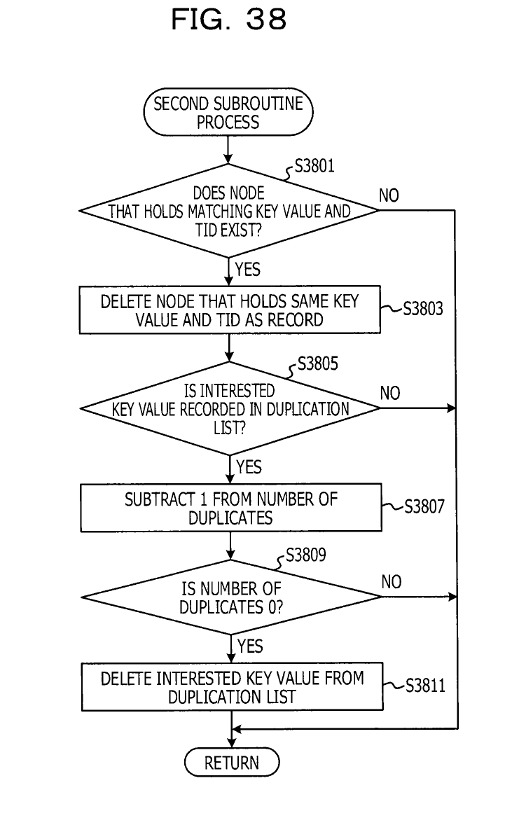

FIG. 38 is a flowchart of the second subroutine process. The reflecting unit 3011 determines whether or not a node that holds the key value and the TID that match the key value and TID of the record identified in S3601 or S3613 illustrated in FIG. 36 exists (in S3801).

If the reflecting unit 3011 determines that the node that holds the key value and the TID that match the key value and TID of the identified record does not exist, the process corresponding to the deletion of the record from the table of the database is already terminated, the second routine process is terminated, and the process returns to the process of S3611 illustrated in FIG. 36. This process corresponds to handling of the record 905 illustrated in FIG. 9 and having the key value “30” and the TID “1800”, for example.

On the other hand, if the reflecting unit 3011 determines that the node that holds the key value and the TID that match the key value and TID of the identified record exists in S3801, the process corresponding to the deletion of the record from the table of the database is yet to be terminated, and the reflecting unit 3011 deletes the node having the same key value and TID as the identified record (in S3803). This process corresponds to handling of the record 907 illustrated in FIG. 9 and having the key value “20” and the TID “1000”, for example.

The reflecting unit 3011 determines whether or not the key value of the identified record is already recorded in the duplication list 1401 (in S3805). If the reflecting unit 3011 determines that the key value of the identified record is not recorded in the duplication list 1401, the reflecting unit 3011 terminates the second subroutine process, and the process returns to the process of S3611 illustrated in FIG. 36.

On the other hand, if the reflecting unit 3011 determines that the key value of the identified record is already recorded in the duplication list 1401 in S3805, the reflecting unit 3011 subtracts 1 from the number, corresponding to the interested key value, of duplicates (in S3807). The reflecting unit 3011 determines whether or not the number of duplicates after subtracting 1 is 0 (in S3809). If the reflecting unit 3011 determines that the number of duplicates after subtracting 1 is 0, the reflecting unit 3011 deletes the record of the interested key value from the duplication list 1401 (in S3811). The duplication list 1401 is updated by the processes of S3807 to S3811, as represented in the middle part of FIG. 15, for example. If the reflecting unit 3011 determines that the number of duplicates after subtracting 1 is not 0 in S3809, the reflecting unit 3011 terminates the second subroutine process. When the second subroutine process is terminated, the process returns to the process of S3611 illustrated in FIG. 36.

Return to the description of FIG. 36. The reflecting unit 3011 determines whether or not the record identified in S3601 or S3613 is the last record (in S3611). If the reflecting unit 3011 determines that the identified record is not the last record, the reflecting unit 3011 identifies the next record (in S3613). Then, the process returns to the process of S3603.

On the other hand, if the reflecting unit 3011 determines that the identified record is the last record, the reflection process is terminated and the process returns to the process of S3203 illustrated in FIG. 32.

Return to the description of S32. The verifying unit 3007 determines whether or not the number of duplicate key values is 1 or more in the duplication list 1401 (in S3203). If the verifying unit 3007 determines that the number of duplicate key values is 1 or more in the duplication list 1401, the removing unit 3017 removes the added data and the new index (in S3205). Then, the switching unit 3003 sets the pointer 1803 provided for the index region of the normal mode and included in the control data storage unit 1609 and switches the current mode 1801 to the “normal mode” (in S3207). In this case, the existing index region pointer 1805 included in the control data storage unit 1609 is copied to the pointer 1803 provided for the index region of the normal mode and included in the control data storage unit 1609. The collectively adding unit 213 returns a return value representing a failure to the loader unit 107 (in S3209). Then, the process returns to the process of S3101 illustrated in FIG. 31 through a terminal 3.

On the other hand, if the verifying unit 3007 determines that the number of duplicate key values is not 1 or more in the duplication list 1401 in S3203, the verifying unit 3007 executes a cancellation verification process (in S3210). If the cancellation log is applied by the rollback in the transaction cancellation process, the verifying unit 3007 verifies whether or not duplication of nodes occurs in the new leaf node region 509. Specifically, the verifying unit 3007 verifies whether or not the new leaf node region 509 after the rollback satisfies the uniqueness constraint.

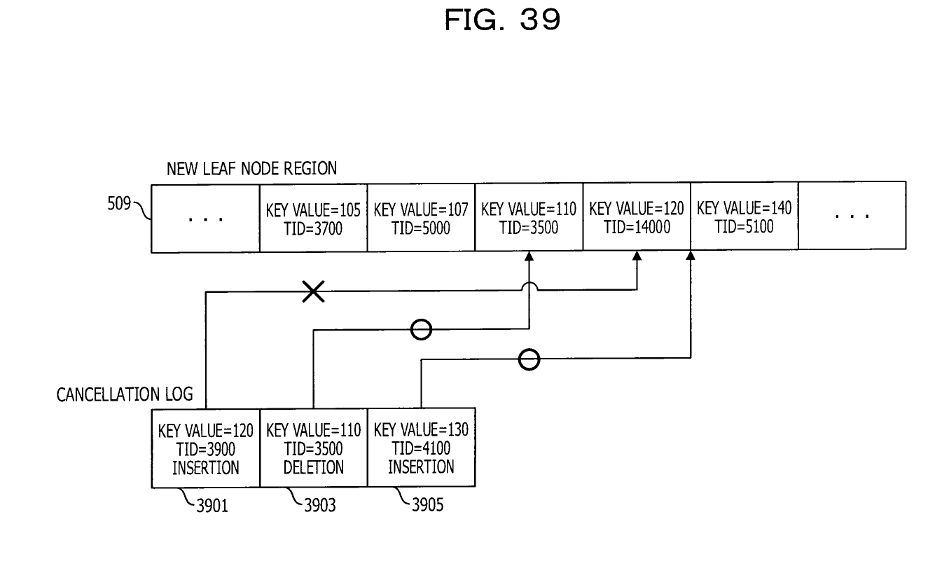

FIG. 39 illustrates a state in which the cancellation log is applied. In a record 3901, details of the cancellation process that are generated when a node that holds a key value “120” and a TID “3900” is deleted from the existing leaf node region 703 are recorded. In a record 3903, details of the cancellation process that are generated when a node that holds a key value “110” and a TID “3500” is inserted in the existing leaf node region 703 are recorded. In a record 3905, details of the cancellation process that are generated when a node that holds a key value “130” and a TID “4100” is deleted from the existing leaf node region 703 are recorded.

When the record 3901 is applied to the new leaf node region 509, the node that holds the key value “120” and the TID “3900” is added to the new leaf node region 509. However, since a node that holds the key value “120” and a TID “14000” already exists in the new leaf node region 509, the nodes that hold the same key value “120” are duplicated. In the example illustrated in FIG. 39, a cross mark represents an application example in which duplication of nodes occurs.

In the new leaf node region 509, the node that holds the key value “110” and the TID “3500” exists. When the record 3903 is applied to the new leaf node region 509, the node that holds the key value “110” and the TID “3500” is deleted from the new leaf node region 509. In this application example, duplication of nodes does not occur. In the example illustrated in FIG. 39, circles represent application examples in which duplication of nodes does not occur.

When the record 3905 is applied to the new leaf node region 509, the node that holds the key value “130” and the TID “4100” is added to the new leaf node region 509. Since a node that holds the key value “130” does not exist in the new leaf node region 509, duplication of nodes does not occur.

Regarding the application of the cancellation log, as illustrated in the application example of the record 3901, when the cancellation process is executed to insert a node in the new leaf node region 509 or the cancellation process of which a node operation type is “insertion” is executed, duplication of nodes may occur. The cancellation verification process is executed to verify whether or not duplication of nodes occurs.

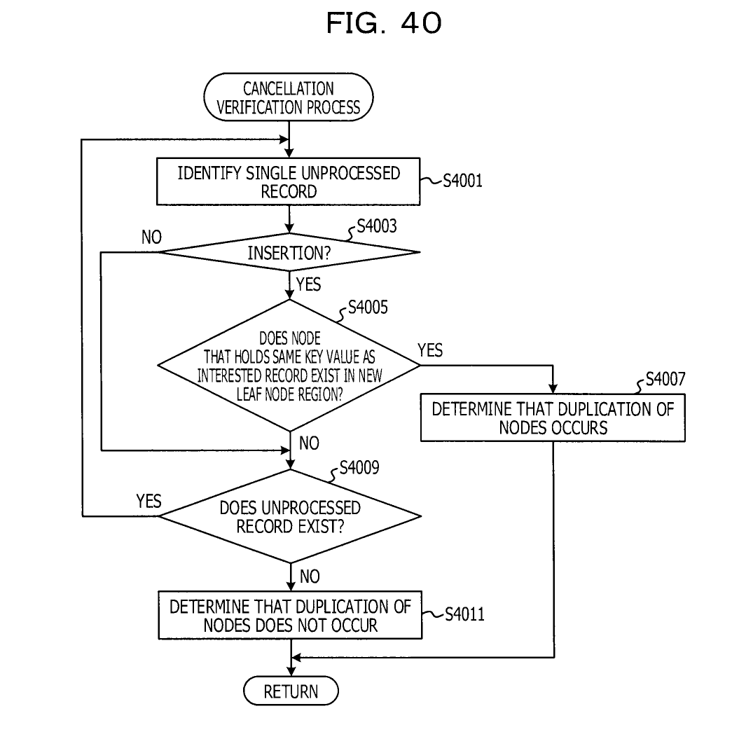

FIG. 40 is a flowchart of the cancellation verification process. The verifying unit 3007 identifies, from the cancellation log, a single unprocessed record or a single record that is not to be processed in S4003 and later (in S4001). The verifying unit 3007 determines whether or not a node operation type of the identified record is “insertion” (in S4003).

If the verifying unit 3007 determines that the node operation type of the identified record is “insertion”, the verifying unit 3007 determines whether or not a node that holds the same key value as the interested record exists in the new leaf node region 509 (in S4005).

If the verifying unit 3007 determines that the node that holds the same key value as the interested record exists in the new leaf node region 509, the verifying unit 3007 determines that duplication of nodes occurs (in S4007). When the cancellation verification process is terminated, the process returns to the process of S3211 illustrated in FIG. 32.

On the other hand, if the verifying unit 3007 determines that the node operation type of the identified record is not “insertion” in S4003 or if the node operation type of the interested record is “deletion”, the verifying unit 3007 determines whether or not an unprocessed record exists in the cancellation log (in S4009).

If the verifying unit 3007 determines that the node that holds the same key value as the key value of the interested record does not exist in the new leaf node region 509 in S4005, the verifying unit 3007 determines whether or not the unprocessed record exists in the cancellation log (in S4009).

If the verifying unit 3007 determines that the unprocessed record exists in the cancellation log, the process returns to S4001, and the aforementioned processes are repeated.

On the other hand, if the verifying unit 3007 determines that the unprocessed record does not exist in the cancellation log, the verifying unit 3007 determines whether or not duplication of nodes do not occur (in S4011). When the cancellation verification process is terminated, the process returns to the process of S3211 illustrated in FIG. 32.

Return to the description of FIG. 32. The process is branched based on whether or not the verifying unit 3007 determines that duplication of nodes occurs in the cancellation verification process (in S3211). If the verifying unit 3007 determines that duplication of nodes occurs in the cancellation verification process, the process proceeds to S3205, and the aforementioned processes are executed. On the other hand, if the verifying unit 3007 determines that duplication of nodes does not occur in the cancellation verification process, the new index is completed at this time. Then, the determining unit 3013 sets the new index region pointer 1807 included in the control data storage unit 1609 and records the completion time 1809 of the new index (in S3212).

Subsequently, the standby unit 3015 executes the standby process (in S3213). The standby process causes the reflection process to stand by until all the transactions started before the completion of the new index are completely terminated. The standby process causes the reflection process to be executed again when all the transactions are completely terminated.

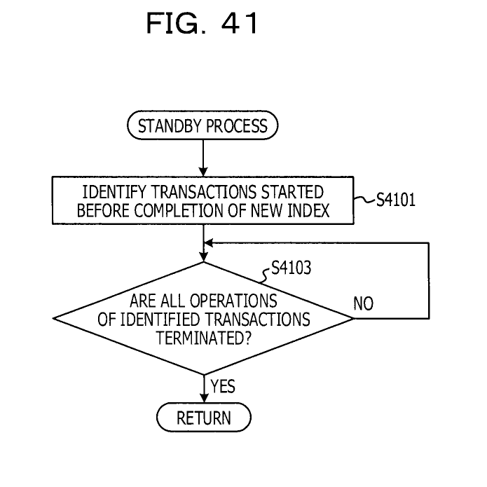

FIG. 41 is a flowchart of the standby process. The standby unit 3015 compares the completion time 1809, stored in the control data storage unit 1609, of the new index with start times in records of the transaction table storage unit 1605 and thereby identifies the transactions started before the completion of the new index (in S4101). If a start time in a record of the transaction table storage unit 1605 is before the completion time 1809, stored in the control data storage unit 1609, of the new index, a transaction corresponding to the interested record is started before the completion of the new index.

Then, the standby unit 3015 determines whether or not all operations of the transactions identified in S4101 are terminated (in S4103). Specifically, if “completion” or “cancellation” is set in the records corresponding to the interested transactions in the status field in the transaction table storage unit 1605, the standby unit 3015 determines that the operations of the interested transaction are terminated. If an operation of any of the identified transactions is yet to be terminated, the process of S4103 is repeated. When all the operations of the identified transactions are terminated, the standby process is terminated and process returns to S3215 illustrated in FIG. 32.

Return to the description of FIG. 32. The switching unit 3003 sets the pointer 1803 provided for the index region of the normal mode and included in the control data storage unit 1609 and switches the current mode 1801 to the “normal mode” (in S3215). In this case, the new index region pointer 1807 included in the control data storage unit 1609 is copied to the pointer 1803 provided for the index region of the normal mode and included in the control data storage unit 1609. The removing unit 3017 removes the existing index region 701 (in S3217). The collectively adding unit 213 returns a return value representing success to the loader unit 107 (in S3219). Then, the process returns to the process of S3101 illustrated in FIG. 31 through the terminal J.

According to the embodiment, since even the update of an index by the individual update during the generation process is reflected in a new index through a history, the individual update is executed even during the collective update.

In addition, it is possible to ensure the atomicity of transactions started before the completion of the new index.

In addition, it is possible to inhibit duplication in the new index.

In addition, it is possible to ensure the uniqueness of the database after the collective update.

Furthermore, it is possible to guarantee the uniqueness of the database for a rollback.

The embodiment is described above, but is not limited to this. The aforementioned functional block configuration may not match a program module configuration.

The configurations of the aforementioned storage regions are an example and may not be the same as the aforementioned configurations. In addition, the orders in which the processes are executed may be changed in the process flows as long as the results of the processes are the same as described above. Furthermore, two or more of the processes may be executed in parallel as long as the results of the processes are the same as described above.

The aforementioned database server 101 is a computer device and includes a memory 2501, a central processing unit (CPU) 2503, a hard disk drive (HDD) 2505, a display controller 2507, a driving device 2513, an input device 2515, and a communication controller 2517 that are connected to each other through a bus 2519, as illustrated in FIG. 42. The display controller 2507 is connected to a display device 2509. The driving device 2513 is provided for a removable disk 2511. The communication controller 2517 is connected to a network. An operating system (OS) and an application program for executing the process according to the embodiment are stored in the HDD 2505. The OS and the application program are read from the HDD 2505 into the memory 2501 and executed by the CPU 2503. The CPU 2503 controls the display controller 2507, the communication controller 2517, and the driving device 2513 based on details of the process of the application program and thereby causes the display controller 2507, the communication controller 2517, and the driving device 2513 to execute predetermined operations. In addition, data that is being processed is mainly stored in the memory 2501, but may be stored in the HDD 2505. In the embodiment, the application program for executing the process is stored in the computer-readable removable disk 2511, distributed, and installed in the HDD 2505 from the driving device 2513. The application program may be installed in the HDD 2505 through the network such as the Internet and the communication controller 2517. The computer device achieves the aforementioned various functions by causing the hardware such as the CPU 2503 and the memory 2501 and the programs such as the OS and the application program to closely collaborate with each other.

The embodiment is summarized as follows.

The update method according to the embodiment includes recording a history of details of the update of individual records of the database, extracting storage positions of a plurality of records from update data to be used to collectively update the plurality of records of the database, generating a second index in which the extracted storage positions of the records are applied to a first index in the database, and reflecting, in the second index, at least details of the update that are after the start of the generation of the second index and are included in the history.

When the update of the individual records of the database after the start of the generation of the second index is reflected in the second index through the history, the individual update may be executed even during the collective update of the database.

A process of updating the first index and the second index together with the update of the individual records after the completion of the second index until transactions started before the completion of the second index are terminated may be included.

It is, therefore, possible to guarantee the atomicity of the transactions started before the completion of the second index.

A log to be used to execute a rollback for the details of the update may be recorded. In addition, when the rollback is executed based on the log, whether or not duplication of key values occurs may be verified.

In this case, it is possible to inhibit the duplication in the second index.

In the generation process, the storage positions of the records and key values of the records may be extracted and applied to the first index, and whether or not duplication of key values occurs in the second index may be detected. In the reflection process, whether or not duplication of key values occurs due to the application of details of update may be detected. A process of determining that the second index is completed if the duplication of the key values does not occur may be included.

In this case, it is possible to ensure the uniqueness of the database after the collective update.

In the recording process, the log to be used to execute the rollback may be recorded. A process of verifying whether or not duplication of key values occurs when the rollback is executed may be included.

In this case, it is possible to guarantee the uniqueness of the database for the rollback.

A program that causes a computer to execute the process by the aforementioned method may be generated and stored in a storage device or a computer-readable storage medium such as a flexible disk, a CD-ROM, a magnetic optical disc, a semiconductor memory, or a hard disk, for example. Intermediate results of the process may be temporarily stored in a storage memory such as a main memory in general.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An update method executed by a computer, the update method comprising:
recording a history of processes executed on records in a database in accordance with a request;
generating a second index, respectively, for a plurality of new records added to the database in accordance with another request, by applying a storage position to a first index of the plurality of records respectively; and
reflecting, to the second index, at least one process from among the processes, the at least one process being executed after a start of the generating of the second index.

2. The update method according to claim 1, further comprising
after a completion of the generating of the second index, updating the first index and the second index according to updating of an individual records from among the records until transactions started before the completion are terminated.

3. The update method according to claim 1, wherein
the recording records, in the history, times when the processes are started, and
the reflecting reflects the at least one process which is not reflected at the time when the second index is generated.

4. The update method according to claim 1, wherein
the generating extracts key values of the plurality of records along with the storage position, applies the key values to the first index respectively, and detects a duplication of key values occurs in the second index, and
the reflecting determines that the second index when completed if the duplication does not occur.

5. The update method according to claim 1, further comprising:
recording a log to be used to execute a rollback for details of the processes; and
verifying whether each of key values of the records is duplicated when the rollback is executed based on the log.

6. An updating device comprising:
a memory; and
a processor coupled to the memory and configured to:
record a history of processes executed on records in a database in accordance with a request,
generate a second index, respectively, for a plurality of new records added to the database in accordance with another request, by applying a storage position to a first index of the plurality of records respectively, and
reflect, to the second index, at least one process from among the processes, the at least one process being executed after a start of a generation of the second index.

7. The updating device according to claim 6, wherein the processor is configured to:
after a completion of the generation of the second index, update the first index and the second index according to updating of an individual records from among the records until transactions started before the completion are terminated.

8. The updating device according to claim 6, wherein the processor is configured to:
record, in the history, times when the processes are started, and
reflect the at least one process which is not reflected at the time when the second index is generated.

9. The updating device according to claim 6, wherein the processor is configured to:
extract key values of the plurality of records along with the storage position,
apply the key values to the first index respectively,
detect a duplication of key values occurs in the second index, and
determine that the second index is completed when the duplication does not occur.

10. The updating device according to claim 6, wherein the processor is configured to:
record a log to be used to execute a rollback for details of the processes, and
verify whether each of key values of the records is duplicated when the rollback is executed based on the log.

11. An update method executed by a processor, the update method comprising:
receiving a plurality of first commands;
executing first processes on records in a database based on the plurality of first commands, respectively;
storing a history of the first processes;
receiving a second command;
executing a second process for an addition of a plurality of new records to the database based on the second command,
executing a generation process of an index according to the addition of the plurality of new records;
identifying, based on the history, a certain first process from among the first processes, the certain first process being executed before a completion of the generation process; and
updating, based on the certain first process, the index generated by the generation process.
